(19) United States
(12) Patent Application Publication
(10) Pub. No.: US 2014/0379317 A1
(43) Pub. Date: Dec. 25, 2014

(54) GEOLOGICAL ANALYSIS TOOL

(71) Applicant: Enersoft Inc., Calgary (CA)

(72) Inventors: Grant I. SANDEN, Millerville (CA); Todd A. STEDEL, Calgary (CA); Curtis G. TAMBLYN, Calgary (CA); Mikhail KOSTOUSOV, Calgary (CA); Yannai Z.R. SEGAL, Calgary (CA)

(21) Appl. No.: 14/314,791

(22) Filed: Jun. 25, 2014

Related U.S. Application Data
(60) Provisional application No. 61/839,162, filed on Jun. 25, 2013.

(51) Int. Cl. E21B 43/00; G06T 11/60; G06T 3/40

(52) U.S. Cl. CPC E21B 43/00; G06T 3/40; G06T 11/60
USPC 703/10

(57) ABSTRACT

Systems, methods, and machine-executable coded instruction sets for associating map, enterprise, and geostatistical data for mapping and otherwise analyzing properties of geological deposits, resource recovery and other enterprises, and geostatistical data.

### FIELD OF THE INVENTION

The disclosure herein relates to the field of geological and geostatistical analysis, and particularly to systems and methods for fully and/or semi-automated geological and geostatistical analysis.

### BACKGROUND OF THE INVENTION

Hydrocarbon exploration, geothermal evaluation, and other applications involving subsurface geostatistics often involve large volumes of data and numerous techniques and parameters for modeling geostatistical information. This data can include many combination(s) and permutations of enterprise, geological, and geostatistical data, which may be generated, stored, and or made available by large and diverse numbers of public, private, academic, and government sources.

There remains need for efficient management, manipulation, analysis, presentation, and control of such data, and systems and methods which fill such needs.

### SUMMARY OF THE INVENTION

In various aspects and embodiments the invention provides systems, devices, methods, and machine-executable instruction sets for associating map, enterprise, and geostatistical data for mapping and otherwise analyzing properties of geological deposits, resource recovery and other enterprises, and geostatistical data.

Thus, according to one very broad aspect, there is provided a geological analysis tool, comprising one or more processors configured to: associate, with surface map data accessed from at least one networked surface map data resource: enterprise data accessed from one or more enterprise data resources, and subsurface geostatistical data accessed from the same or other data resources; and generate, using at least portions of the associated map data, enterprise data, and geostatistical data, signals useful for displaying a geological map comprising indicia representing subsurface geostatistical information associated with at least one location on the surface of the earth; and write the generated signals to at least one memory accessible by at least one display device.

In some embodiments, optionally, the networked map data resource comprises at least one dynamically-updated surface data.

In some embodiments, optionally, the one or more processors is configured to access at least one analytic tool, the analytic tool configured to enable the same or at least one other processor to execute at least one analysis of geostatistical data associated with at least a portion of the geological map.

In some embodiments, optionally, the enterprise data relates at least to a drilled well.

In some embodiments, optionally, the enterprise data relates at least to a mine.

In some embodiments, optionally, the enterprise data relates at least to recovery of geothermal energy.

In some embodiments, optionally, the enterprise data relates to at least one subsurface resource deposit.

In some embodiments, optionally, the one or more processors is configured to access at least one enterprise analytic tool, the enterprise analytic tool configured to enable the same or at least one other processor to execute at least one analysis of the same or other enterprise data associated with at least a portion of the geological map.

In some embodiments, optionally, the signals useful for displaying a geological map are generated at least partly using a graphics visualization tool that enables selective rendering and manipulation of data to be written to memory for display.

In some embodiments, optionally, the graphics visualization tool enables selective rendering of data based on a zoom level.

In some embodiments, optionally, the graphics visualization tool enables selective rendering of data based on a projection orientation.

In some embodiments, optionally, when an update to the surface map data, the enterprise data, or the subsurface geostatistical data is detected, the one or more processors are configured to associate the updated data.

In some embodiments, optionally, the one or more processors are configured to provide authentication information to access one or more of the data resources.

According to another very broad aspect, there is provided a geological analysis tool, comprising one or more processors configured to: in response to signals representing a command to display well bore image data, access data representing a plurality of images of at least a portion of an interior surface of a well bore; using the accessed image data, generate signals useful for displaying on a display device a composite image representing at least a portion of the plurality of images, the generated signals configured to scale the displayed composite image to fit a predetermined portion of a display screen; and in response to signals representing a user designation of a portion of the displayed composite image, generate signals useful for displaying on a display device an enlarged view of the designated portion.

In some embodiments, optionally, the one or more processors are configured to access subsurface geostatistical data associated with the well bore, and the generated signals configured to scale the displayed composite image to fit a predetermined portion of a display screen are configured to display the composite image in alignment with geostatistical information associated with the well bore, as a function of well depth.

According to yet another very broad aspect, there is provided a geological analysis tool, comprising one or more processors configured to: in response to signals representing a command to display well bore image data, access data representing a plurality of images of at least a portion of an interior surface of a well bore; access subsurface geostatistical data associated with the well bore, and using the accessed image data and geostatistical data, generate signals useful for displaying on a display device a composite image representing at least a portion of the plurality of images. The generated signals are configured to scale the displayed composite image to fit a predetermined portion of a display screen; and display the scaled composite image in alignment with associated geostatistical information, as a function of well depth.

In some embodiments, optionally, the one or more processors are configured to: in response to signals representing a user designation of a portion of the displayed composite image, generate signals useful for displaying on a display device an enlarged view of the designated portion.

In some embodiments, optionally, the subsurface geostatistical data includes oil or gas concentration data.

In some embodiments, optionally, the subsurface geostatistical data includes mineral content data.

In some embodiments, optionally, the subsurface geostatistical data includes water content data.

In some embodiments, optionally, the subsurface geostatistical data includes geothermal data.

In some embodiments, optionally, the one or more processors are configured to access at least one enterprise analytic tool, the enterprise analytic tool configured to enable the same or at least one other processor to execute at least one analysis of at least a portion of the subsurface geostatistical data.

In some embodiments, optionally, the generated signals configured to scale the displayed composite image to fit a predetermined portion of a display screen are configured to display the composite image in alignment with multiple sets of separately displayed geostatistical information.

In some embodiments, optionally, generating the signals useful for displaying on a display device a composite image representing at least a portion of the plurality of images comprises applying image processing to individual images before displaying the processed individual images as a composite image.

In some embodiments, optionally, applying image processing comprises: reorienting, rearranging, or aligning the individual images.

In some embodiments, optionally, the one or more processors are further configured to determine a respective well depth for each of the plurality of images using an automatic character recognition process and, based on the determined well depth of each respective image, arrange the plurality of images within the composite image as a function of well depth.

According to yet another very broad aspect, there is provided a geological analysis tool, comprising one or more processors configured to: send to a system associated with a first client, signals useful for displaying a geological map comprising indicia representing geostatistical information associated with at least one location on the surface of the earth; in response to receiving, from the system associated with the first client, annotation data associated with one or more objects, store the annotation data; and send to a system associated with a second client, signals useful for displaying the geological map including an annotation based on the annotation data.

In some embodiments, optionally, the one or more processors are configured to, in response to receiving, from the system associated with the second client, second annotation data associated with the same or other objects, store the second annotation data.

In some embodiments, optionally, the one or more processors are configured to send the signals including the annotation to the system associated with the second client when the second client is authorized to access the annotation data.

In some embodiments, optionally, the one or more processors are configured to send signals useful for displaying or hiding the annotation based on a filter, a selection or a search criterion.

In some embodiments, optionally, the one or more objects comprise locations, wells, indicia, or data.

According to yet another very broad aspect, there is provided a geological analysis tool, comprising one or more processors configured to: identify geostatistical data associated with a subsurface volume defined at least partly based on input received from a client device, the input representing a selected portion of a geological map; access at least one library of geostatistical analysis data sets, each accessed library comprising at least one analytic tool data set comprising coded instructions configured to cause the same or another processor to execute one or more geostatistical operations with the geostatistical analysis data set; and perform at least one geostatistical operation on the geostatistical data associated with the subsurface volume.

In some embodiments, optionally, the one or more processors are configured to define, based at least partly on operation information received from, determined by, and/or generated by the client system, a sequence of at least two geostatistical operations to perform on the geostatistical data associated with the subsurface volume.

In some embodiments, optionally, the operation information is received in response to selections inputted at the client system.

In some embodiments, optionally, the one or more processors are configured to provide a development environment accessible at the client system, the development environment configured for displaying, modifying and/or executing computer language code corresponding to at least one of the geostatistical operations.

In some embodiments, optionally, the development environment includes elements for defining at least one of: a sequence of operations, parameters for each operation, and global parameters.

In some embodiments, optionally, the elements for defining the sequence of operations includes elements for defining how an output of a designated operation is applied to an input of a subsequent operation.

In some embodiments, optionally, the one or more processors are configured to compile, interpret, and/or execute instructions represented by the computer language code.

In some embodiments, optionally, the development environment configured to access other stored code files or libraries.

In some embodiments, optionally, the one or more processors are configured to generate signals useful for displaying a graphical user interface at the client system, the graphical user interface including selectable geostatistical operations.

In some embodiments, optionally, the graphical user interface includes elements for defining at least one of: a sequence of operations, parameters for each operation, and global parameters.

In some embodiments, optionally, the elements for defining the sequence of operations includes elements for defining how an output of a designated operation is applied to an input of a subsequent operation.

In some embodiments, optionally, the one or more processors are configured to store data representing an analysis recipe including at least a portion of the received operation information.

In some embodiments, optionally, the graphical user interface includes one or more elements defining a pre-defined multi-step recipe.

In some embodiments, optionally, the one or more geostatistical operations include at least one of: local analysis (such as nearest neighbour or Krige analysis), stationary simulation (such as Sequentially Gaussian Simulation, or Sequential Indicator Simulation) or non-stationary methods (such as locally-varying anisotropy analysis).

In some embodiments, optionally, the one or more geostatistical operations include a mathematical data transform (such as Normal Score, or Projection Pursuit Multivariate Transform).

In some embodiments, optionally, the one or more processors are configured to store an analysis history including the performed operations and data generated by the operations.

In some embodiments, optionally, the data generated by the operations includes data generated by intermediate operations.

In some embodiments, optionally, the one or more processors are configured to associate the analysis history with the selected portion of the geological map.

According to yet another very broad aspect, there is provided a geological analysis tool, comprising at least one processor configured to display in a first graphical user interface a plurality of indicia representing data points associated with a plurality of geological resources; in response to an input identifying at least one of the plurality of indicia, display information associated with at least one geological resource; and in response to an input selecting one of the plurality of indicia, display in a second graphical user interface, additional information associated with the at least one associated geological resource.

In some embodiments, optionally, the first graphical user interface comprises a variogram.

In some embodiments, optionally, displaying the information in response to the input identifying the indicia comprises displaying well information.

In some embodiments, optionally, displaying the additional information comprises displaying a map including a location associated with the at least one geological resource.

In some embodiments, optionally, the at least one processor is configured to, in response to an input selecting another of the plurality of indicia, display a map including a second location associated with another geological resource.

In some embodiments, optionally, the first graphical user interface is displayed in a first web browser interface, and the second graphical user interface is displaying in a second web browser interface.

In some embodiments, optionally, there is further included at least one processor configured to control, manage, divide or share processes between a first web browser and a second web browser.

According to yet another very broad aspect, there is provided a geological analysis tool, comprising at least one processor configured to: display a geological map comprising at least one deposit, the geological map including direction vectors associated with at least one geostatistical property of the reservoir, for example, related to deposit anisotropy, each direction vector based at least partly on direction-vector data; using input generated interactively by a user, determine curve data, which may include data representing one or more zero and/or non-zero vector, associated with the same or other geostatistical properties of the deposit, based on the determined curve data and the direction-vector data, generate data representing at least one modified/hybrid direction-vector associated with the at least one property; and write to volatile or persistent memory data useful for displaying the at least one direction-vector.

In some embodiments, optionally, the at least one processor is configured to display a curve on the geological map based on the input generated by the user input device.

In some embodiments, optionally, the geological map includes a two-dimensional representation of a region including the at least one deposit.

In some embodiments, optionally, the geological map includes a three-dimensional representation of a region including the at least one reservoir.

In some embodiments, optionally, the geological map includes a plurality of two-dimensional layers.

In some embodiments, optionally, the curve data is determined at least partly using a plurality of user-generated input vectors.

In some embodiments, optionally, the curve data is determined at least partly using a user-designated zero vector.

In some embodiments, optionally, generating the data representing the at least one modified direction-vector is based on a weighting of the curve data relative to the direction-vector data.

In some embodiments, optionally, the weighting is selected by an weighting input.

### BRIEF DESCRIPTION OF THE DRAWINGS

The invention is illustrated in the figures of the accompanying drawings, which are meant to be exemplary and not limiting, and in which like references are intended to refer to like or corresponding parts.

FIGS. 1 and 2 are schematic block diagrams showing functional elements of embodiments of systems suitable for use in implementing aspects of the invention.

FIG. 3 is a schematic flow diagram illustrating a process suitable for use in implementing data association, display, and processing in accordance with aspects of the invention.

FIGS. 4-63 show embodiments of user interface screens and devices suitable for use in implementing aspects of the invention.

### DESCRIPTION OF EMBODIMENTS

Preferred embodiments of methods, systems, and apparatus suitable for use in implementing various aspects of the invention are described through reference to the drawings.

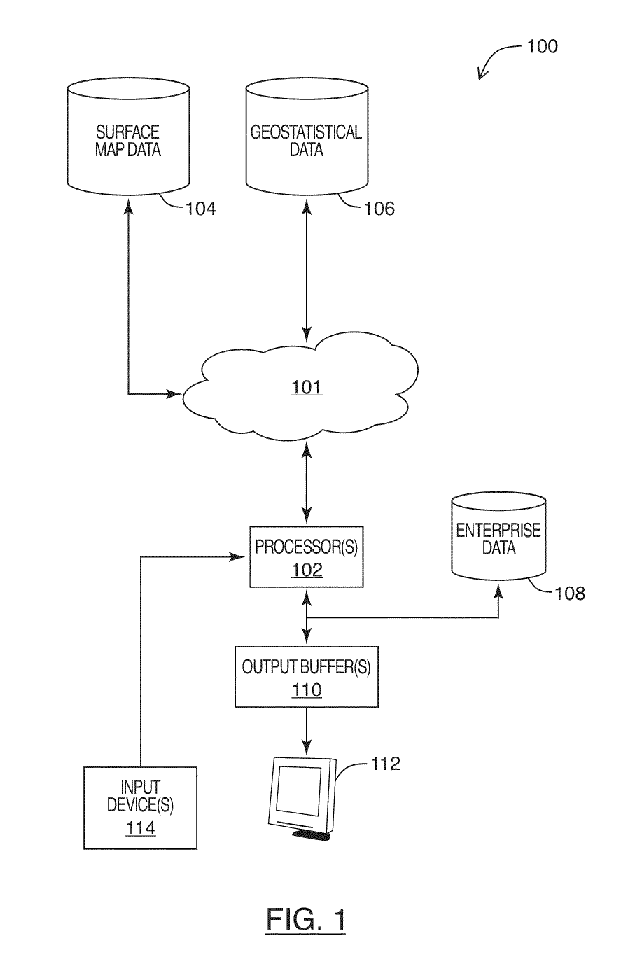

An example of a system 100 suitable for use in implementing aspects of the disclosure is shown schematically in FIG. 1. In the embodiment shown, system 100 comprises one or more processors 102, network 101, at least one networked geographical map resource 104, and geostatistical and enterprise data resource(s) 106, 108 respectively.

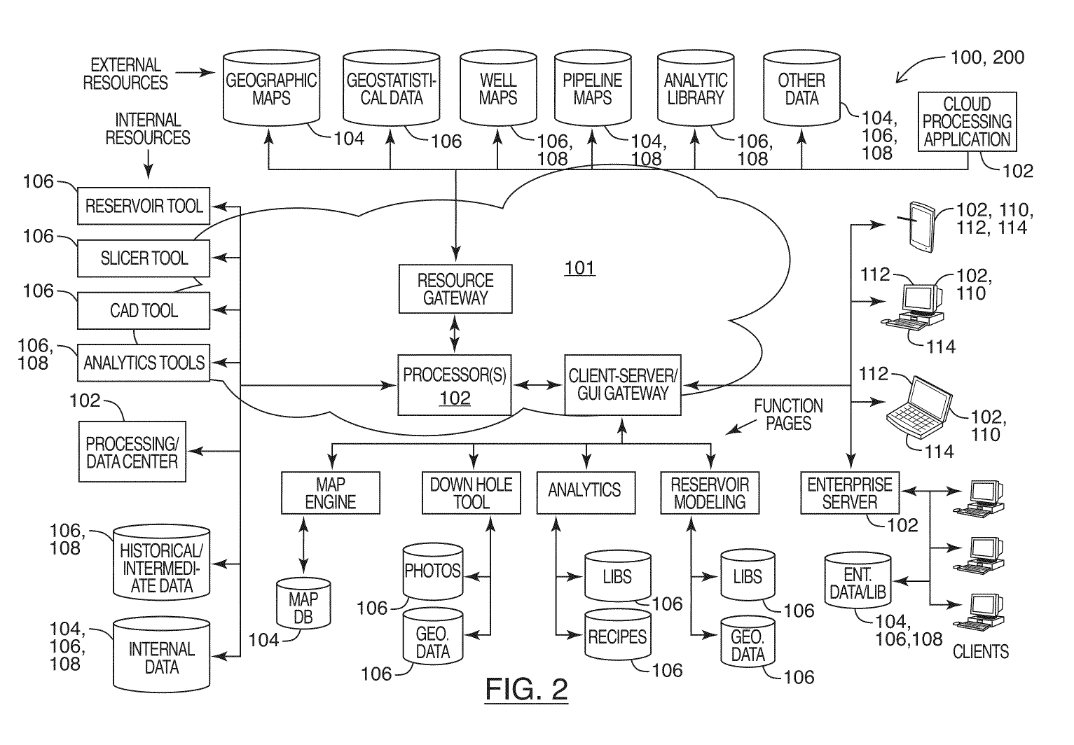

A geological tool can be implemented using various aspects of the system 100, in various forms and combinations. In various senses, a geological tool in accordance with the invention can be, or incorporate, or combine, both hardware aspects, such as the various components of system 100 shown in FIGS. 1 and 2, and/or software, firmware, and/or other logical structures comprising machine executable commands suitable for use in executing any of the various processes disclosed herein.

System and device aspects of geological tool(s) in accordance with the disclosure can include, and/or be executed by, any desired or otherwise suitable numbers of processors 102. Processor(s) 102 serve to access, collate, and/or otherwise process data from local and networked data resources 104, 106, 108, etc; and, using such accessed data, generate signals and/or data suitable for use in displaying, analyzing, and/or otherwise processing geological, geostatistical, and broad varieties of enterprise data. For example, in various embodiments processor(s) 102 can be configured to associate surface map data accessed from the at least one networked geographical map resource 104 with enterprise data and subsurface geostatistical data from enterprise data resource(s) 108 and geostatistical data resource(s) 106, respectively. Using the associated map, enterprise, and geostatistical data, processor(s) 102 can generate signals useful for displaying two-, three, or four-dimensional geological map(s). Generated signals can be written to local or networked memory(ies) such as, for example, display and/or other output buffer(s) 110 which can be accessed by a display or other output device 112 for displaying or otherwise presenting the geological map.

Geological maps generated with such tools, or otherwise through the use of such processes, can in various embodiments include indicia representing subsurface geostatistical and/or enterprise information associated with location(s) on the surface of the earth.

In various examples, as will be understood by those skilled in the relevant arts, various forms of control input can be provided to processor(s) 102 through the use of any one or more of a very wide variety of input devices 114, any or all of which which can be connected locally or remotely via local, wide-area, and enterprise network(s) 101. Such input devices can, for example, include locally-connected keyboards, keypads, pointing devices, and the like; and/or remotely-connected stand-alone computers such as laptops, desktops, notebooks, tablets, and/or any other mobile or networked computing device(s).

Map data resource(s) 104 can include any one or more databases, memories, servers or other devices or systems from which map data suitable for use in implementing the objects disclosed herein can be accessed by processor(s) 102. Map data can, for example, include geographic map data, topographical data, political map data, land use data, land ownership or zoning data, general-purpose map data, and/or any other type(s) of map data suitable for purposes disclosed herein. In various examples, map data can include topographical and/or other geological information; land-use information such as mineral and other deposits and reservoirs, conservation areas, transportation information such as roadways, railroads, pipelines, etc; land ownership or licensing data; hydrographic, hypsographic; demographic/population information, etc. Such data may be stored, or otherwise made available, in any format(s) or manner(s) consistent with the purposes disclosed herein.

Map data resource(s) 104 can be locally maintained and/or accessed via network(s) 101. In various embodiments, it can be advantageous for map data provided at 104 can be generated, maintained, updated, and/or otherwise processed on a continual (or “dynamic”) basis. Networked resource(s) 104 for providing such constantly or frequently updated data can be provided or managed by, for example, third party service(s) such as Google™ Maps, Bing™ Maps, or public source(s) such as a government-funded or operated server(s). In some embodiments, one or more networked map resources 104 can be operated or managed by various types of business enterprises, such as oil drilling, mining, or resource exploration companies, and/or by providers of geological analysis tools, such as universities, research institutions, or others.

Geostatistical data resource(s) 106, which may be local, remotely networked, or both, can include one or more databases, servers and/or other devices or systems containing data stored in any suitable form, including in file sets, file directories, and the like, from which any desired geostatistical data can be accessed by processors(s) 102. Geostatistical data can include any data relating to surface or subsurface properties of the earth (or other bodies, including for example the moon or any of the planets), including for example mining operations, petroleum geology, hydrogeology, hydrology, meteorology, oceanography, geochemistry, geometallurgy, geography, forestry, environmental control, landscape ecology, soil science, and agriculture. Such data can, for example, include information pertaining to the location(s), content(s), and distribution(s) of reservoirs and other deposits of water, minerals, petroleum, and other things; seismic data; geothermal data, petrophysical data, composition data, lidar data, and/or other subsurface geostatistical data.

In various embodiments, geostatistical data resource(s) 106 can provide access to, or otherwise include, library(ies) of geostatistical analysis tools. Such tools can provide data useful for enabling one or more processors 102 to perform various geostatistical analysis operations, such as applying various types of algorithms or formulae to defined sets of geostatistical data.

Enterprise data resource(s) 108, which may be local, remotely networked, or both, can include one or more databases, servers or other devices or systems containing data stored in any suitable form, including in file sets, file directories, and the like, from which enterprise data can be accessed by one or more processors 102. Enterprise data can include data related to, collected by, accessible to, or otherwise controlled by any business, government, academic or research organization, or other enterprise or entity interested in using geostatistical data or geological analysis for any purpose, including for example exploration, drilling, mining, recovery, or other purposes. Enterprise data resource(s) 108 may be public, private, governmental, or of any other type or form, including proprietary or open; like all other resources contemplated herein, they may be subject to access restrictions by means of passwords, encryption, etc. Enterprise data can include geostatistical data or map data, as well as any design, installation, plant, production, composition, processing, or other enterprise-related data.

In some examples, enterprise data can include data relating to planned or drilled wells, mines, recovery of geothermal energy, or recovery of subsurface resource deposit(s). Well data can, for example, include production data, core photos or images, completion data, lab results, petrophysical data, or any other information of interest to such enterprises. In various examples, enterprise data can include annotation data or data for authorizing or controlling access to enterprise data.

While example enterprise data resource(s) 108 are illustrated in FIG. 1 as comprising an individual data base or data set associated directly with processor(s) 102 and output buffer(s) 110, it is to be understood that the enterprise data resource(s) 108, like all other resource(s) 104, 106, etc., can be physically or logically located anywhere in the system 100, including for example at or via a remote location connected to the processor(s) 102 via network(s) 101. The enterprise data resources 108 can include resources controlled and operated by the enterprise as well as resources controlled and operated by third parties such as cloud based service providers.

The enterprise data provided by enterprise data resource(s) can be in a raw (e.g., un-processed) form, for example, as generated at its source. Such raw data may be in files of any type, including word processing documents, spreadsheets, text files, such as comma-separated value (CSV) files, image files, and others. In such cases, one of more processors 102 may be configured for read access of the data files without modification.

However, in alternative embodiments, as explained in more detail below, in some cases, the enterprise data resource(s) 108 may be pre-processed by processor(s) 102 using a variety of different input tools or functions in order to extract data or metadata useful for associating the enterprise data with map and/or geostatistical data. Such pre-processing by processor(s) 102 can include automated extractions of certain data, such as identification data, as well as associations of enterprise data from different input files based on the extracted data. Thus, in some cases, processor(s) 102 may be able to identify a plurality of different files containing enterprise data relating to the same item (such as a well bore), extract data of interest, and then organize the extracted data into a composite or other more intuitive form.

As specific examples, enterprise data resource(s) 108 can include both information to be used in the various type(s) of display and analysis disclosed herein, and information, data, and other results of such analyses.

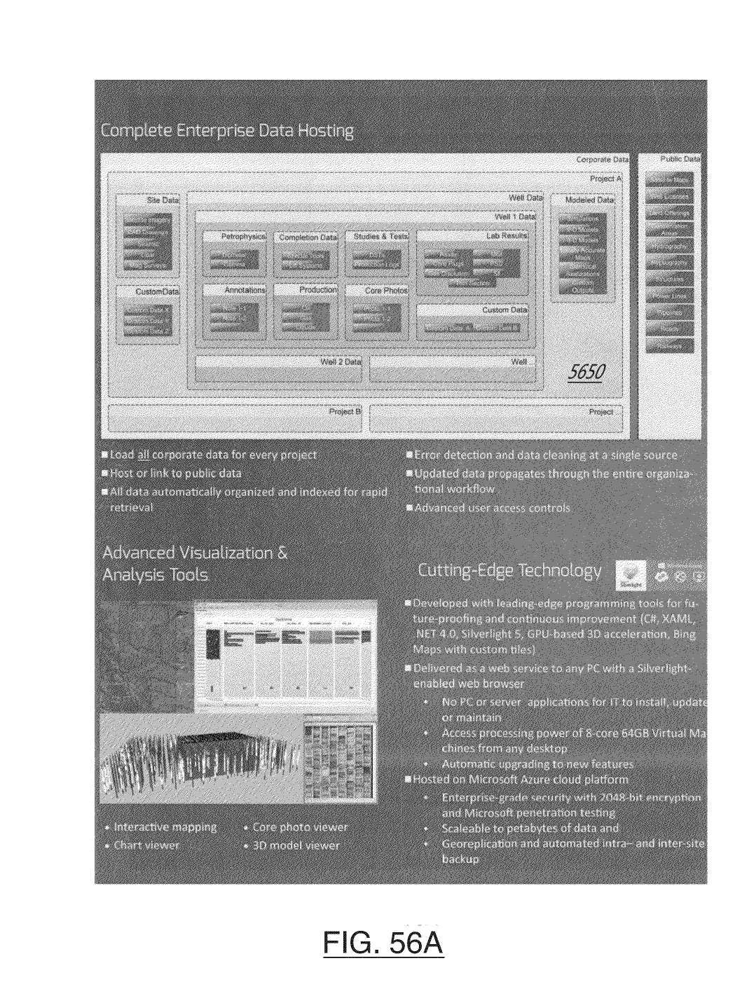

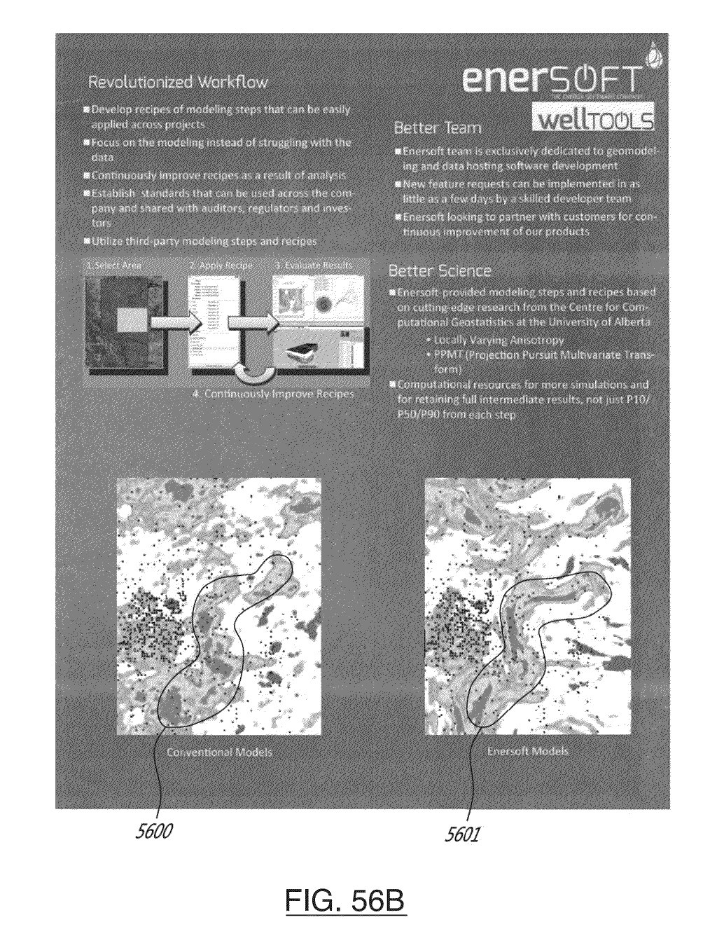

An example of a range of enterprise data made available by a system 100, 200 in accordance with the invention, from a plurality of local and networked resources 108 is shown at 5650 in FIG. 56A. Various (sub)sets and components of the data types shown at 5650 are described below.

While map resource(s) 104 and geostatistical data resource(s) 106, are illustrated in FIG. 1 as individual data resource(s) associated with individual locations or sources, each such resource can include any number(s) of devices, memory(ies), or systems of any suitable type(s), located at any number of locations and controlled by any number of entities.

In some examples, map data resource(s) 104, geostatistical data resource(s) 106, and/or enterprise data resource(s) 108 may overlap. For example, they can be stored on common databases or other systems, and/or stored in unified data sets. Thus, individual resource data sets 104, 106, 108 can include any or all of enterprise data, map data, and/or geostatistical data. Copies or caches of data can also be located at various resources or locations in the system 100.

In various embodiments, access to any or all of resources 104, 106, 108 may be controlled to limit access to data. Any or all such resource(s) can be managed, maintained, provided, or otherwise made available by any suitable public or private source(s), including for example government agencies, various types of business enterprises, and/or other party(ies), any of whom may control access through the use of various security devices, including for example various types of user i.d./password authorizations, tokens, subscriptions, or pay-per-use models. In some examples, map resources 104 can be managed by the geological analysis tool.

Display and/or other output buffers or memory(ies) 110, and any/or all of resources 104, 106, 106, etc. can comprise any number(s) and/or type(s) of volatile and/or persistent memories useful for holding or otherwise storing signals representing generated for display, analytic, record-keeping, control, and/or other purposes consistent with the disclosure herein. Such memories may include any combination(s) of volatile or persistent memory(ies), such as flash, RAM, ROM, hard-drives, solid-state drives, at the like. Such memory(ies) can have stored thereon data or instructions which when executed cause the device or resource to perform any activity related to the operation of the systems, tools, devices, or methods described herein.

All data bases and other memory(ies) associated with resources and buffers 104, 106, 108, 110, etc., disclosed herein may be of any type(s) suitable for use in implementing the systems and methods disclosed herein, and can for example include any one or more flash memory(ies), random-access memory(ies), hard-disk drives, solid-state drives, or any other data storage device(s) suitable for storing signals and accessible by at least one display device, analysis system, or other processor(s) 102, etc. In various examples, memory(ies) 110 can include one or more display buffer(s), and/or memory(ies) associated with graphics card(s) or device(s). Like all other memory(ies) described herein, buffer(s) 110 can be local to processor(s) 102 and/or networked for communications therewith.

One or more displays and/or other output device(s) 112 can be locally or remotely connected to the one or more memories 110 to access or otherwise receive from, and use, signals generated by processor(s) 102 and stored in buffer(s) 110 to display geological map(s), analytical results, and/or other data or outputs represented thereby. Display(s) and/or other output device(s) 112 can include any output device(s) consistent with the purposes disclosed herein, including for example liquid-crystal displays (LCDs), light-emitting diode (LED) displays LED, cathode ray tube (CRT) displays, printer(s), audio speakers, and/or any other display device(s) suitable for use in displaying or otherwise reviewing, memorializing, or considering data in accordance with the purposes disclosed herein.

Input device(s) 114 can include any keyboards, pointing and/or selecting device(s) such as mice, touchpads, touchscreens, and/or any other signal-generating device(s) suitable for providing control and/or other input commands to, and/or otherwise interacting with processor(s) 102 and associated devices.

Another example of a system 100 suitable for use in implementing aspects of the invention is shown at 200 in FIG. 2. In the embodiment shown, system 100, 200 includes processors 102 at a variety of locations, implemented in a variety of forms and in association with a wide variety of peripherals and other devices, any one or more of which may be linked locally or remotely by, for example, local and/or wide-area network(s) 101 such as the internet. For example, processors 102 can be located at or in conjunction with one or more servers, resources, client devices, or processing/data centers. One or more of processor(s) 102 at one or more locations can comprise part of a distributed geological analysis tool, as for example shown in FIG. 2 and described below.

In the embodiment shown in FIG. 2, system 100, 200 further includes a variety of networked map resources 104, geostatistical data resources 106, and enterprise data resources 108 at various network locations and associated with a variety of devices in the system 100, 200. For example, such resources can include external resources which may be hosted, operated or controlled by third party(ies); internal resources which may be hosted, operated or controlled by locally-implemented processor system 102; and enterprise resources which may be hosted, operated, administered, or otherwise controlled by an enterprise or entity.

In many circumstances, it can be advantageous for processor(s) 102 and various portions, combinations, and/or components of resource(s) 104, 106 to be hosted, operated, administered, or otherwise controlled by an enterprise which also controls one or more enterprise resources 108 as proprietary data source(s).

In various embodiments, system(s) 100, 200 can provide, for example as a part of or in conjunction with any or all of geostatistical resource(s) 106 and/or enterprise resource(s) 108, various forms of geostatistical and enterprise analysis tools such as reservoir analysis tools, slicer tools, computer-aided design tools, or other analytic tools, as described herein. In some examples, such tools can be internal to (i.e., securely or otherwise directly controlled by) processor(s) 102 which control the geostatistical analysis tool, and/or they can be external and can be hosted or controlled by a third party or enterprise, via network(s) 101, etc.

Geostatistical analysis tool(s) or engine(s) 100, 200 in accordance with the invention may, in various embodiments, be advantageously implemented wholly or partly through the use of distributed processing techniques. For example, some or all of processor(s) 102 and associated functions can be efficiently implemented through the use of various forms of hosted, optionally distributed service(s) and/or other virtual machine(s). Suitable examples include cloud platforms such as Windows Azure™ or Amazon Elastic Compute Cloud™.

Cloud platform(s) and other devices or systems can further be used to store any or all historical, intermediate, and/or other data generated by system(s) 100, 200, including for example results of the various geostatistical analysis operations described herein. For example, for many analysis applications buffered data and/or other internal data representing initial and/or boundary conditions, intermediate results, and/or final results can be stored to promote efficiency in further or subsequent analysis operations. In such embodiments, any or all individual beginning, intermediate, and/or final steps or results of any or all analyses or processes stored herein may be publicly, privately, or otherwise stored for later reference, output, and/or use. Storage of such initial, boundary, intermediate, and/or final results can particularly useful where, for example, complex algorithms are applied in various forms of geostatistical analysis.

In various embodiments it may be advantageous, for purposes of communications, security, and other forms of efficiency, for system(s) 100, 200 to include various forms of client-server and/or graphical-user interface gateway(s). For example, in various embodiments both the security and efficiency of communications between processor(s) 102 and any or all resource(s) 104, 106, 108, 110, etc. can be improved by reading and/or writing data via such gateways.

As will be disclosed more fully below, system(s) 100, 200 can advantageously employ a wide variety of graphical-user interface(s) (GUI(s)), and associated processing and data resources, for facilitating user input and output functions. GUI(s) in accordance with the disclosure can provide particular advantage with respect, for example, to the implementation and control of map engines, down-hole and analytics tools, reservoir modeling, etc.

As illustrated in FIGS. 1 and 2, any combination(s) of suitable resources, devices and systems in any suitable network topology(s) can be used to implement aspects of the invention. Enterprise, geostatistical, and analytical data and resources can be provided both remotely and locally.

Network(s) 101, as will be understood by those skilled in the relevant arts, may be provided in any suitable form, a wide variety of which are now known, either singly or in various combinations, and doubtless other varieties of which will hereafter be developed. Such network(s) may include either or both of wired and wireless components and protocols.

Processor(s) 102 can include any suitable general and/or specific-purpose processing unit(s), microprocessors, graphics processing units, digital signal processors, or any electromagnetic or other suitable digital signal processor. A wide variety of suitable devices are now available, and doubtless others will hereafter be developed.

As will be apparent to those skilled in the relevant arts, once they have been made familiar with this disclosure, systems 100 can be provided in any of a very wide variety of forms, using a wide variety of type(s) and combination(s) of devices, components, and subsystems. The examples shown in FIGS. 1 and 2, and described throughout the disclosure, are meant to be exemplary and not in any way limiting.

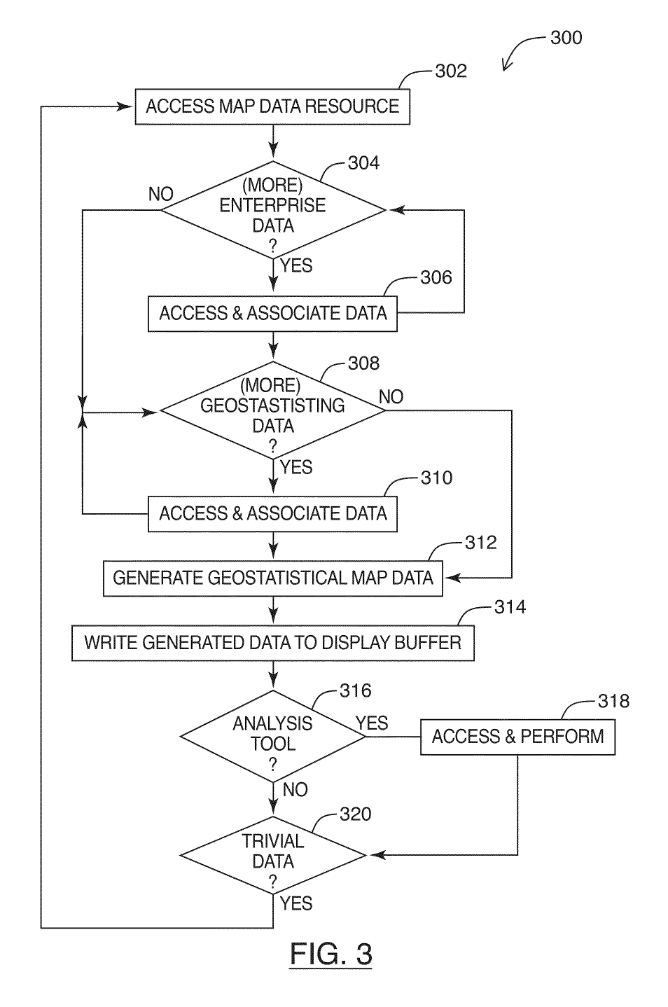

FIG. 3 is a schematic flow diagram illustrating a process 300 suitable for use in generating data useful for display of geological maps and for other initiating forms of analysis in accordance with various aspects and embodiments of the invention. Process 300 is suitable for implementation using, for example, system(s) 100, 200 as shown in FIGS. 1 and 2, and the various components thereof.

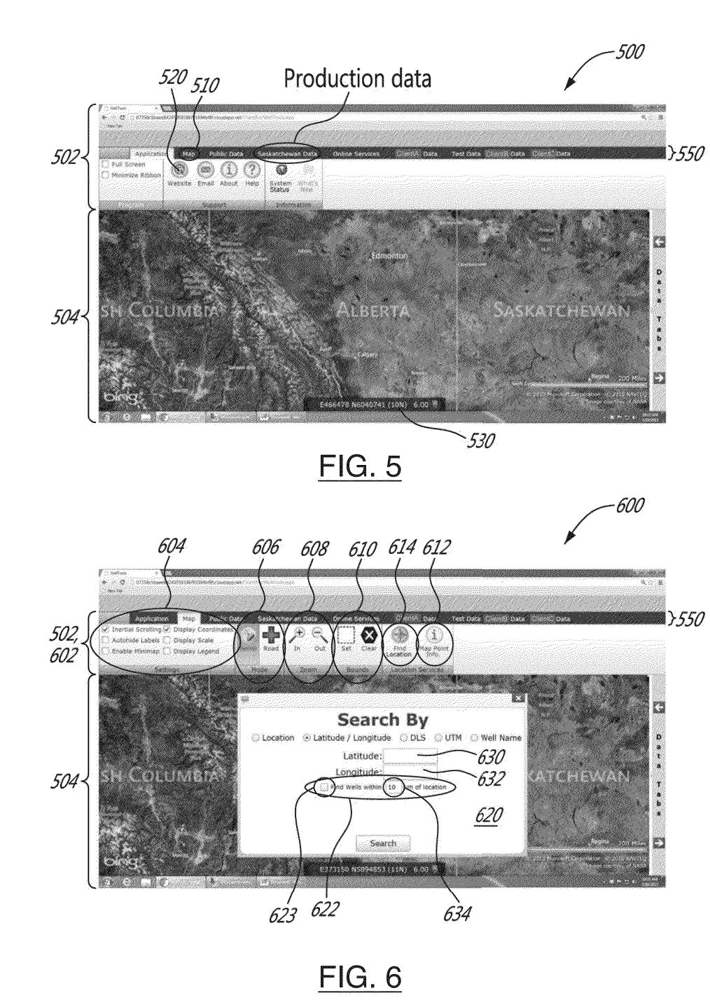

It will be understood that the process shown in FIG. 3 is provided as an example only. The functions accomplished through use of such a process may be implemented in a wide variety of ways. For example, an analysis tool of the kind controlled through use of GUIs such as those shown in FIGS. 5-10, etc., and described below, may be operated without reference to relatively rigid process flows such as that shown in FIG. 3. Rather, processor(s) 102 may simply poll input buffer(s) adapted to receive input signals from input device(s) 114 for input, interpret received, buffered signals, in relationship to command actions (i.e. selection of icons) and corresponding interactive GUI elements and items, and navigate directly to functions/functionalities designated by users.

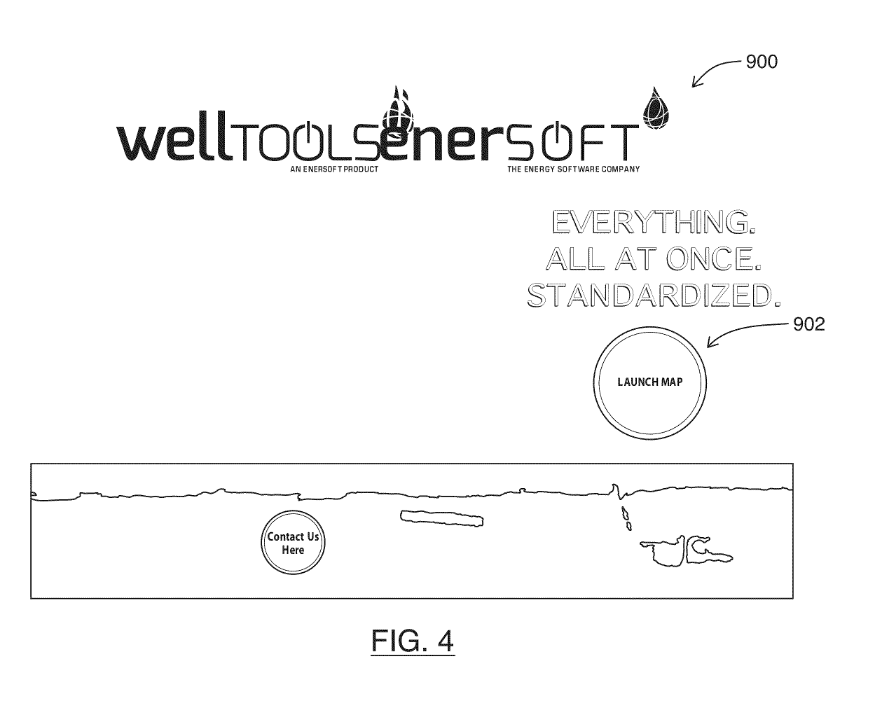

At 302, in a process 300, one or more processors 102 can be caused to access map data, such as topographical, satellite composite photo image, and/or other surface map data, from one or more local and/or networked map resources 104. For example, one or more input device(s) 114, such as a keyboard and/or pointing device, may be used to initialize or otherwise invoke a geological analysis tool by, for example, selecting an application icon on a “desktop” GUI displayed on a display 112 of a desktop, laptop, tablet, or palmtop computer 102, or by navigating to a website and selecting an application “launch” icon 902 on an application homepage 900, as shown for example in FIG. 4, using one or more input devices 114 in conjunction with a browser GUI presented on such a display 112. Selection of an icon 902 using pointing device can for example cause a processor 102 associated with the user's input device(s) 114 to generate and process for execution instructions configured to initialize a geological analysis tool application resident in a local enterprise data set 108, in a networked geostatistical data resource 106, and/or in other suitable memory, and present an application interface GUI such as that shown, by way of example, at 500 in FIG. 5.

GUI 500 of FIG. 5 can, for example, be generated by processor(s) 102 by invoking such resident or networked geological analysis tool, reading and executing data representing suitably-configured stored machine executable-instruction sets to generate interactive multi-function toolbar 502, access networked map data resource 104 to retrieve requested or default map data, and display a map window 504.

As previously noted, in many embodiments of systems 100, 200, it can be advantageous for map resource(s) 104 to comprise actively-maintained or—updated databases of data suitable for use by processor(s) 102 in generating and/or otherwise preparing signals suitable for use in displaying desired map data on display(s) 114, etc., and/or otherwise processing related data. For example, some preferred embodiments of systems 100, 200 employ publicly-available “dynamic” map databases such as Google®, Bing®, etc., which are updated on a substantially continuous basis.

In the embodiment shown in FIG. 5, display 500 comprises one or more multi-function toolbars 502 which provide interactive GUI elements which enable user(s), through use of input device(s) 114 such as keyboards, pointing devices, etc., to initiate and control a wide variety of graphical and analytical functions. In the embodiment shown, for example, toolbar 502 comprises interactive elements corresponding to functions logically grouped under headings 550 “Application”, “Map,” “Public Data”, “Production (or “Enterprise”) Data,” “Online Services”, “ClientA Data,” “Test Data,” and “Private (or “Enterprise”) Data”. While, as will be understood by those skilled in the relevant arts, such elements and functional grouping(s) may be used to invoke and otherwise control processes useful in implementing a very wide variety of mapping and analysis functions, only a few are described herein, and they are described in various currently-preferred specific manners and embodiments. Both they and other functions may be implemented in a wide variety of ways which are not specifically disclosed herein, but will be understood thoroughly by those skilled in the relevant arts, once they have been made familiar with this disclosure.

If for example map window 504 is not centered or otherwise focused on a desired location within the mappable region represented by data available from or through resource(s) 104, a user of input device(s) 114 can cause the geological analysis tool application to retrieve and display such data (or “navigate to a desired location”) by, for example, navigating, through use of a pointing device, to functional grouping item 510, “Map”, and activating a switch to generate and execute a “selection” command adapted to cause toolbar 502, to present a variety of map-related control functions associated with control of map display(s), in a map grouping toolbar 602, as shown in FIG. 6.

Map navigation GUI 600 shown in FIG. 6 provides interactive elements enabling a wide range of map-display and map-control functionalities. For example, “Settings” grouping 604 enables a user to select (i.e., activate or deactivate), using input device(s) 114, a number of map display and navigation preferences, including an option to scroll map display window 505 in an “inertial manner,” such as those now commonly used in display scrolling functions; to display or not display local coordinates of object(s) of interest using, for example, latitude and longitude, or other coordinate systems; to display or hide mileage, meter, and other distance scales of displayed maps or map portions; to display legends such as mountain, lake, river, and road names; to hide or display various types of labels, etc.; and to display or not display selected sub-maps, or “minimaps”.

“Mode” grouping 606 enables a user to selectively display a photographic, topographic, or other “aerial view” of the region(s) displayed in map window 504, or to display road maps or other non-photo based images of features of the displayed map area.

“Zoom” grouping 608 enables a user to interactively select relative scale(s) of map(s) displayed in map window 504.

“Bounds” grouping 610 enables a user to use an area select tool to define bounds for further control of mapping and analysis functions, as disclosed herein.

“Location services” grouping 612 enables a user to navigate directly to a specific desired location, or to request display of information related to one or more specific, identified locations, by for example selecting a point on a displayed map or by hovering a cursor or other virtual pointing tool over the desired location.

Selection of a “Find Location” item 614 can, for example, result in display of an interactive navigation element 620 which enables a user to select from a number of modes for mapping of a desired location. For example, selection by a user of one of the “radio-button” options “location”, “latitude/longitude,” “DLS”, “UTM”, “well name” enables the use to select a desired mode for searching available map data resource(s) 104 for a corresponding location or region. For example, by selecting the “latitude/longitude” option, as shown in FIG. 6, the user is presented with an option that enables the user to use a pointing device and/or keyboard 114 to enter into an interactive input fields 630, 632 a geographic latitude and longitude, and to request display of a map region in the designated vicinity.

At 304, process 300 can include a determination whether a user of a system 100, 200 wishes to access enterprise data associable with map data accessed at 302, for display, analysis, and/or any other purposes. If so, at 306 process 300 can include accessing such data from one or more local and/or networked enterprise data resources 108. As described herein, such accessed data may be in either a raw (unprocessed) form as generated from its source or, alternatively, following pre-processing in order to extract data or metadata useful for processor(s) 102 to automatically identify an item to which the enterprise data relates, associate the enterprise data with geostatistical and/or map data, generate composites based on extracted data of interest, and so on.

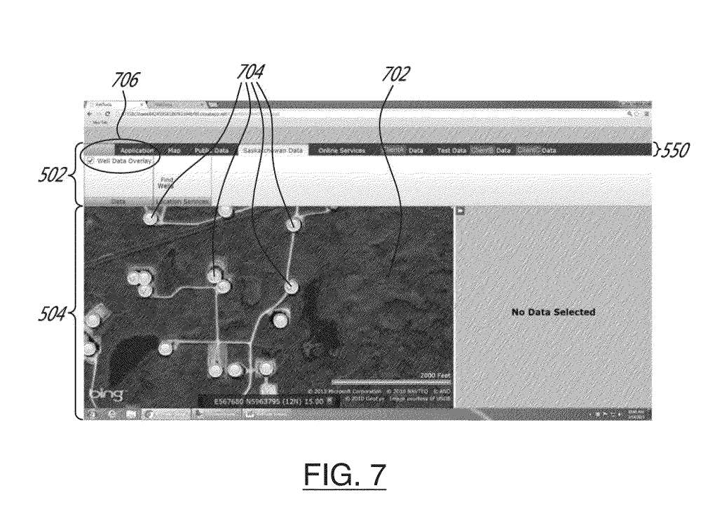

Tool(s) 100, 200 enable association, display, and analysis of various combinations of map, enterprise, and geostatistical data in a wide variety of ways. An example of a means for association and display or other use of enterprise data 108 with map data is shown at 622 in FIG. 6, where a user is provided an option of identifying oil wells within a selected range 634 of the location identified at 630, 632. A range within which such wells are to be identified may, for example, be selected by means of a drop down menu 634. For example, upon entry of suitable input data at 622, e.g., by selection of “check box” 623, and at 634, a user can cause processor(s) 102 to access to one or more enterprise resource(s) 106, 108 to obtain data relating to all known oil wells within the designated radius 634 of the location specified at 630, 632, and to overlay information identifying and/or otherwise associated with such wells on corresponding portion(s) of a display 504 of a map of a region centered on the specified location, as shown for example in FIG. 7.

In the example shown in FIG. 7, a region 702 of an aerial photographic map (which may for example be a map generated as a composite from several satellite or other aerial photographs associated with the region) within a default or selected range of the location designated at 630, 632 is displayed in map window 504. Pursuant to a “selection” input made at interactive element 705, enterprise data in the form of locations of oil wells associated with the displayed area has been accessed from one or more local and/or networked enterprise data resources 108 associated with a URL or other resource identifier “Saskatchewan Data”; and pursuant to selection of an interactive item 706, information identifying location(s) 704 of such wells has been displayed as an overlay on top of the displayed map region 702.

As will be understood by those skilled in the relevant arts, the association and display of data accessed through different resources 104, 106, 108 can be accomplished in a wide variety of ways, many of which are known, and others of which will doubtless hereafter be developed. For example, map data accessed through a map data resource 104 can be mapped into a suitable display array, including for example a 2×2 array of data records stored in a display buffer, each record comprising items representing (i) the absolute or relative location of a picture element (pixel) on a display in two-dimensional (e.g., x-y) space, and (ii) one or more color attributes, including for example relative weights of red-blue-green (RBG) color values. Thereafter, enterprise and/or geological data may be read, scaled or otherwise mapped into corresponding array(s); and as desired the data may be displayed by all or portion(s) of the map array may be overwritten with data associated with corresponding pixels to effectively overlie the previously-buffered display data.

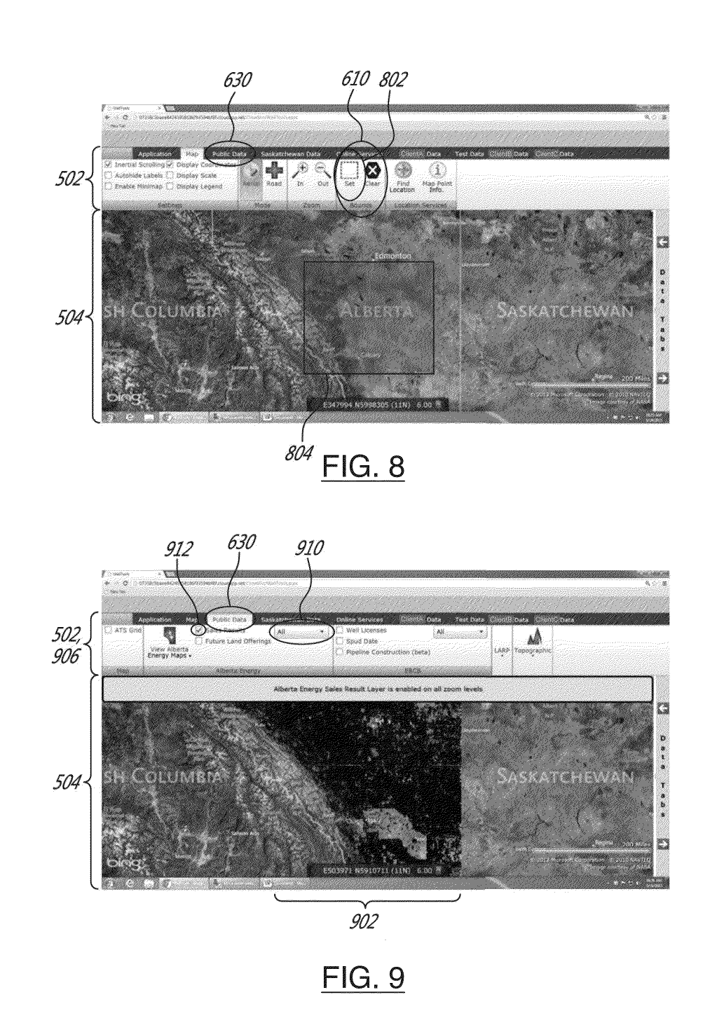

Another example of association at 306 of enterprise data from resource(s) 108 with map data from resource(s) 104 is shown in FIGS. 8 and 9. In the example shown, at 802 a user has selected map control item “Set” in “Bounds” command group 610; the user has thereafter used an interactive tool, such as a drag, drop, and adjust-type image frame overlay of the type provided, for example, in Windows™-type operating systems, to designate a map region 804 for further analysis and display name associated with a desired map display location (such as the name of a town, an address, etc.).

Upon entry of suitable execution command(s), controlling processor(s) 102 can cause the geological analysis tool 100, 200, to display an expanded map in map window 504, the expanded map comprising the map area designated at 804 in FIG. 8, as shown for example at 902. In doing so, processor(s) 102 can further access any local and/or networked map resource(s) 104 to obtain any additional required map data, and/or can otherwise process previously accessed map data to generate the “zoomed” map display window 504 shown in FIG. 9.

As shown in FIG. 9, enterprise data from local and/or networked resource(s) 108 can be associated with displayed map data through selection of one or more suitably-configured GUI command group heading elements 550 and making of further command input selections on further toolbars 502 associated with such headings. In the example shown, GUI command group heading element 630 “Public Data” has been selected, with resultant display of GUI interactive elements 906, and selection of a networked enterprise data resource 108 “Alberta Energy Maps.” Additional default or deliberate selection of GUI elements 912 “Sales Results” and 910 “All” has resulted in overlaid display, at 902, of data representing energy map information provided through the province of Alberta.

Upon display or other writing of enterprise data for association with map data at 306, a (re-)determination can be made at 304 as to whether further enterprise data is to be associated with designated map data.

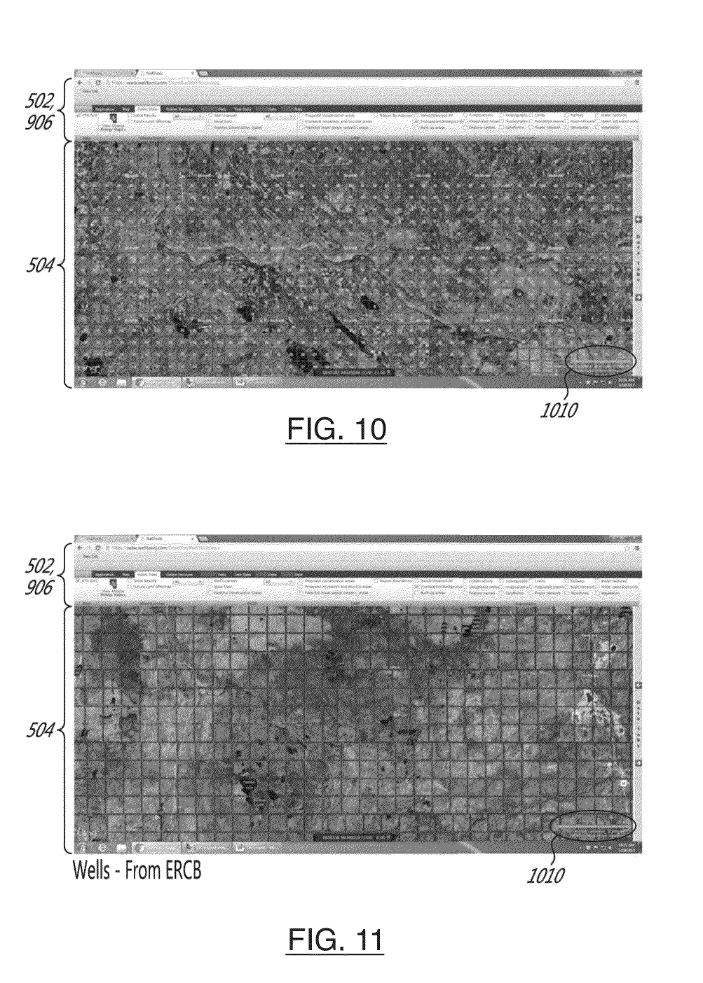

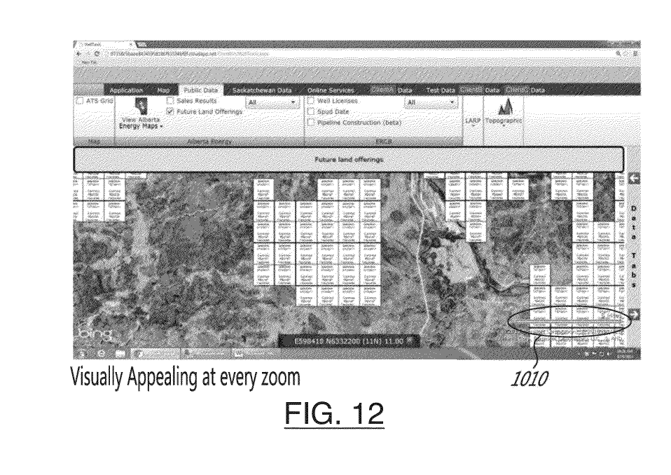

An example of further associations/manipulation(s) of enterprise and map data is shown in connection with FIGS. 10-12. In FIGS. 10-12, the combined Alberta composite photographic map data and Alberta Energy sales maps shown in FIG. 9 is displayed at increasing “zoom” levels, so that as shown at scale bar 1010 in each figure maps centered at the same geographic location but displayed at progressively larger scales are shown. At each such progressively larger scale, greater amounts of information pertaining to each of the land parcels shown may be displayed; accordingly increasingly detailed information is displayed. Such information can for example include, at the various scale levels, any or all of parcel identifier, parcel size, last sale date, tax-assessed price and/or last sale price. Geological analysis system 100 can accomplish this by, for example, reading all associated parcel data at the same time, prior to the initial display of FIG. 9, but with each successive generation of data representing larger-scale maps the information associated with each parcel is re-assessed, and as much information as is legibly convenient is displayed. Determination(s) of what parcel information is available, how much information can be displayed legibly at each scale, and suitable formatting for the display may be determined dynamically, through application of suitably-configured display formatting processes.

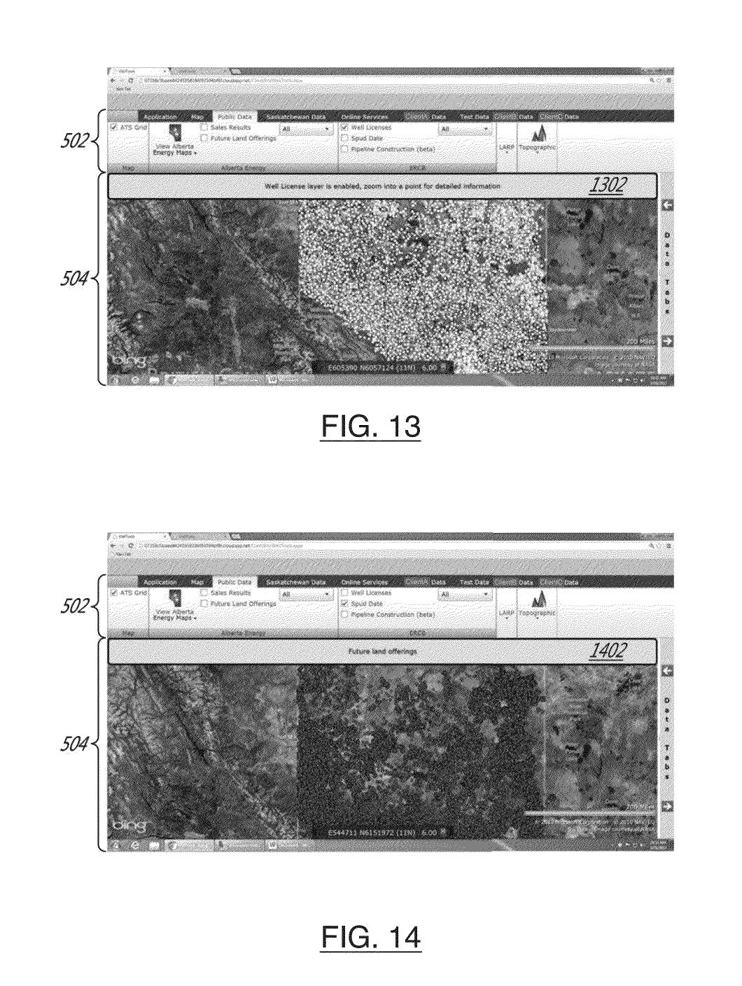

Further examples of the association of enterprise and map data at 304-306 are provided in FIGS. 13-18.

In the example shown in FIG. 13, a networked enterprise data resource “Alberta Energy” has been accessed to provide enterprise data in the form of locations and optionally additional data associated with oil well licenses in the province of Alberta. Using data accessed at the designated “Alberta Energy” resource, signals useful for displaying a map showing a southern portion of that province, with overlaid oil well license data as well as Alberta Township System (ATS) grid information, have been generated, and a corresponding display has been provided in map display window 504. As noted at 1302, additional license-related enterprise data can be accessed, to the extent needed, from the same and/or other enterprise data resource(s) 108, and displayed by zooming to larger scale displays, in a manner similar to that described above with respect to oil well location information.

In the example shown in FIG. 14, a networked enterprise data resource “Alberta Energy” has been accessed to provide enterprise data in the form of locations of a number of oil wells in the province of Alberta, and optionally additional data indicating the dates on which the wells were first drilled (sometimes referred to as “spud dates”). As noted at 1402, additional enterprise data, relating to notices of future land lease/sale offerings, can be accessed, to the extent needed, from the same and/or other enterprise data resource(s) 108, and displayed by zooming to larger scale displays, in a manner similar to that described above with respect to oil well location information.

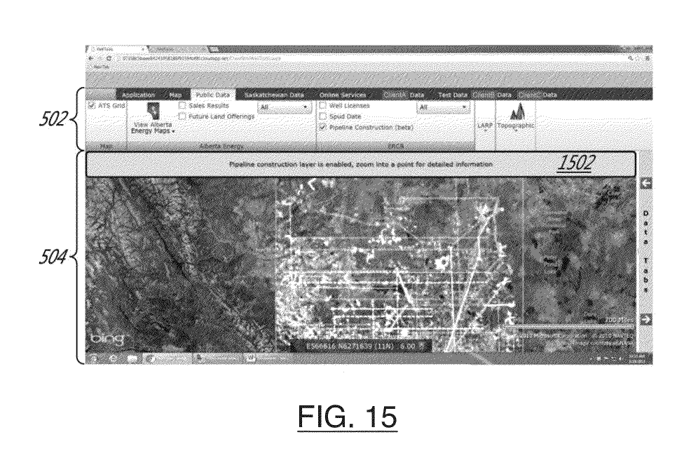

In the example shown in FIG. 15, a networked enterprise data resource “Alberta Energy” has been accessed to provide enterprise data in the form of oil pipelines constructed across portions of the province of Alberta. As noted at 1502, additional enterprise data, including additional details regarding the various pipelines displayed, can be accessed, to the extent needed, from the same and/or other enterprise data resource(s) 108, and displayed by zooming to larger scale displays, in a manner similar to that described above with respect to oil well location information.

Following accessing and optionally display of enterprise data from enterprise data resource(s) 108 at 306, at 304 process 300 can include a determination whether a user of a system 100, 200 wishes to access any further enterprise data, including for example either or both of additional data from the same resource(s) 108 already accessed, and data from further local or networked resource(s) 108. For example, such a process 306-304 can be used to access and display additional enterprise data during “zoom” processes such as those described in connection with FIGS. 8-11.

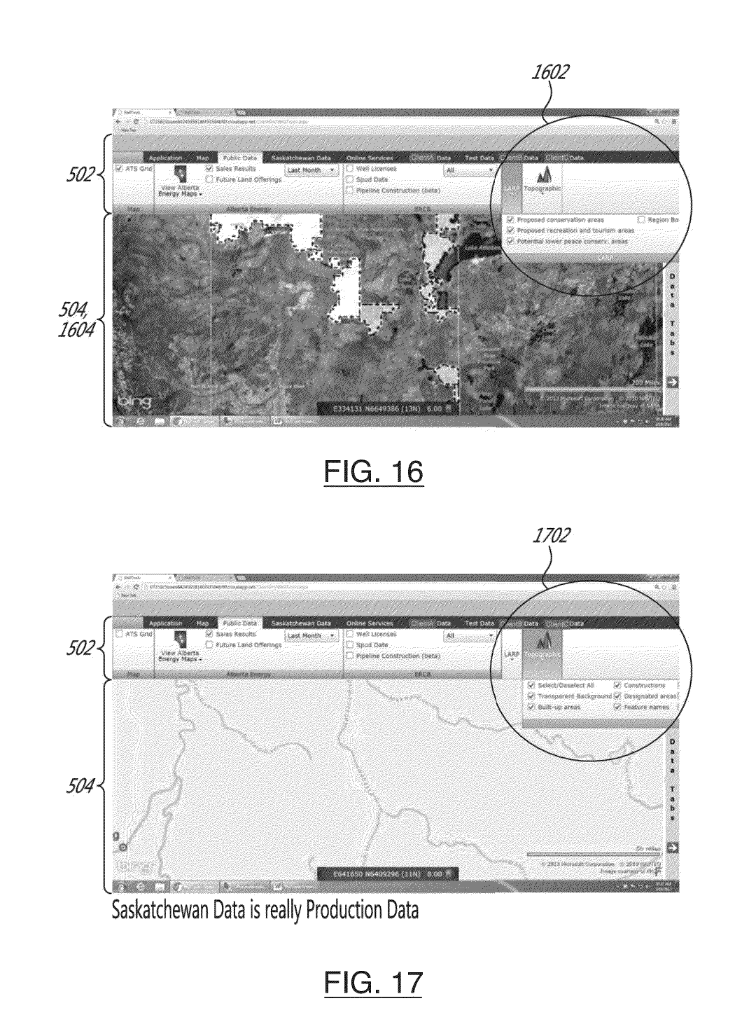

As a further example, FIG. 16 illustrates the accessing, through use of a drop-down menu 1602, of enterprise data made available through a networked enterprise data resource 108 associated with the Lower Athabasca Regional Plan (LARP) within the province of Alberta, and the use of such LARP data to generate and display image overlays representing proposed conservation areas, proposed recreation and tourism areas, and potential lower Peace River Conservation areas on top of previously accessed and displayed map data and enterprise data representing sales information for the mapped region 504, 1604.

FIG. 17 illustrates the accessing, association, and display of topographical features accessed from a map resource 104. In addition, enterprise data in the form of built-up area indicators, construction locations, etc., has been overlaid through the use of a drop-down menu 1702 accessed via an interactive GUI control element “Topographic.”

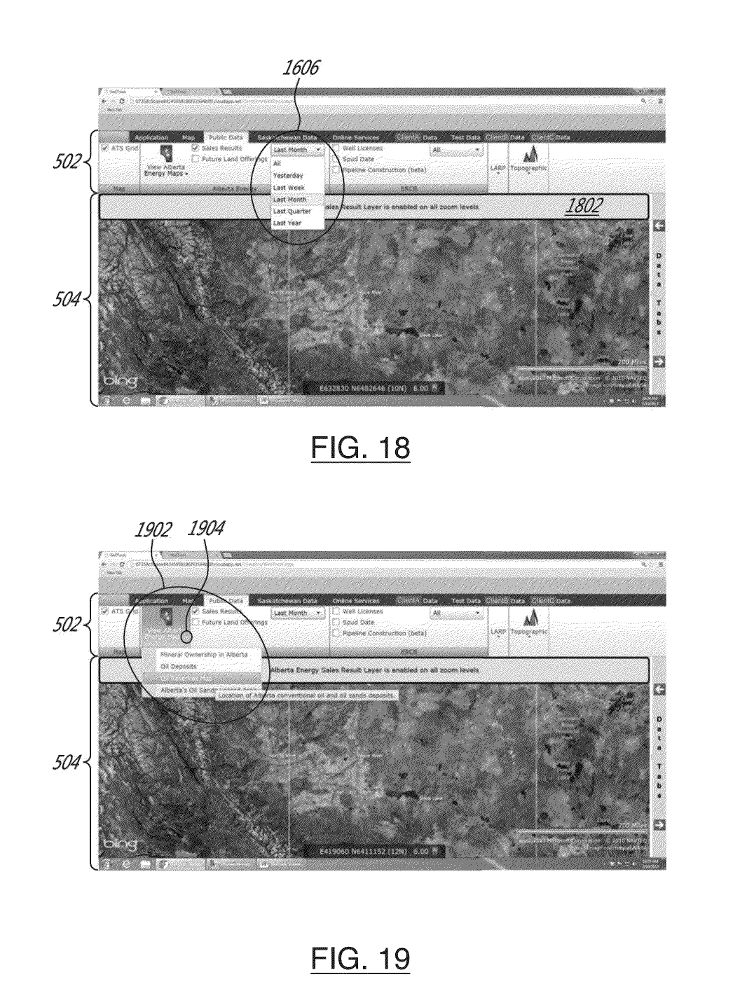

FIG. 18 illustrates further possibilities, including options of accessing further enterprise data from resource(s) 108 through the use of drop-down menus associated with interactive GUI element(s) such as 1606. In the embodiment shown, a user is enabled to use suitable input device(s) 114 to access and select command items adapted to cause display of desired sets of land or concession sales information.

Step(s) 304-306 of process 300 can be repeated until all desired enterprise data resource(s) 108 and data content have been accessed, and optionally displayed.

When it is determined at 304 that no further access to enterprise data is currently desired, at 308 a determination may be made whether any geostatistical data is desired; and if so at 310 such data may be accessed via local and/or networked geostatistical data resource(s) 106.

Alternatively, as noted above, a user of a system 100, 200 may navigate to resources 106 associated with desired geostatistical data directly, through use of GUI command elements such as those illustrated in FIGS. 5-10, etc.

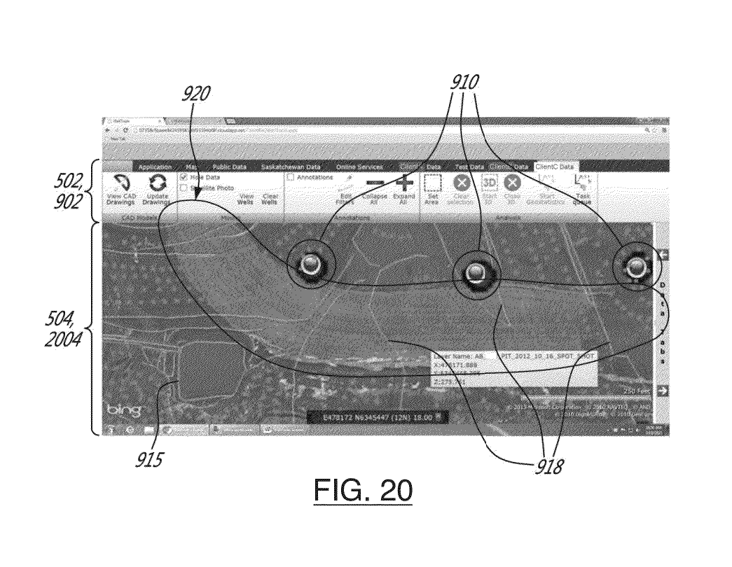

Examples of the association and display of data accessed at networked map data resource(s) 104, enterprise data resource(s) 106, and geostatistical data resource(s) 108 consistent with steps 308, 310 of process 300 are shown in FIGS. 19 and 20.

In FIG. 19, a user has accessed a drop down menu associated with enterprise data from resource(s) 108 “Alberta Energy” through the use of drop-down menu 1902 through selection of an interactive GUI command item 1904 in toolbar 502. In the embodiment shown, the user has selected item “Oil Reserves Map” from the drop-down menu 1902.

FIG. 20 illustrates an example of a possible result of execution of an access-data command associated with selection of an interactive GUI command item 1904 such as that shown in FIG. 19. In FIG. 20, a user has navigated to a composite satellite photo map display 504, 2004 showing a relatively small region within the province of Alberta. The photo map has been overlaid with both enterprise data and geostatistical data from one or more resources 106, 108. Enterprise data 915 represents roads, 918 represents pipelines, and 910 represents drilled oil wells. Geostatistical data 920 from a networked geostatistical data source 106 represents a portion of a bitumen deposit associated with the “Jackpot Mine” in Alberta.

It may be seen that in the example shown in FIG. 20 that geostatistical data has been “translucently” overlaid upon map data in the map display window 504 by modifying RGB data associated with corresponding pixels to present a slightly lighter-toned appearance, rather than simply replacing map color values with color values derived from the displayed geostatistical data. Displayed enterprise data 910, 915, 918, however, has been “opaquely” overlaid by entirely overwriting map-related RGB data with enterprise-related RGB data for corresponding pixels.

As with process step(s) 304-306, process step(s) 308-310 of process 300 may be repeated until all desired geostatistical data resource(s) 108 and data content have been accessed, and optionally displayed.

When adequate initial, intermediate, or final map, enterprise, and/or geostatistical data has been accessed, associated, and further processed as desired, using any or all of local and/or networked resources 104, 106, 108, corresponding display data may be generated by processor(s) 102, and at 314, any desired display data may be generated and written to display buffer(s) or other memory(ies) 110. If/as desired, such display data may be processed by buffer(s) 110 and display(s) or other output device(s) 112 for review or for further processing. Such data may also be stored in any desired type(s) of volatile and/or persistent memory for later accessing, display, analysis, or other processing.

At 316, a determination may be made by the same or other processor(s) 102 whether a user wishes to access any geostatistical or other analysis tool(s), and if it is determined that access to one or more such tool(s) is desired, at 318 such tool(s) can be accessed, and processor(s) 102, alone or in cooperation with other processors associated with, for example, any of map, enterprise, and/or geostatistical resource(s) 104, 106, 108 can initiate and execute corresponding analysis processes.

At 320, a continual process of determining whether any new map, enterprise, or geostatistical data is desired, and if so accessing, displaying, and/or otherwise processing it may be started. Alternatively, as previously noted, functions described herein in connection with process 300 may be implemented in a wide variety of alternative ways. For example, an analysis tool of the kind controlled through use of GUIs such as those shown in Figures and described herein, including for example GUI elements and items 510, 520, 604, 606, 608, 610, 612, 614, 630, 910, etc., may be operated without reference to relatively rigid process flows such as that shown in FIG. 3. Rather, as noted above, processor(s) 102 may simply poll input buffer(s) adapted to receive input signals associated with such GUI elements and items, interpret any received input(s), and execute corresponding commands to allow user(s) to navigate the system and access data, execute analysis tools, etc., as desired.

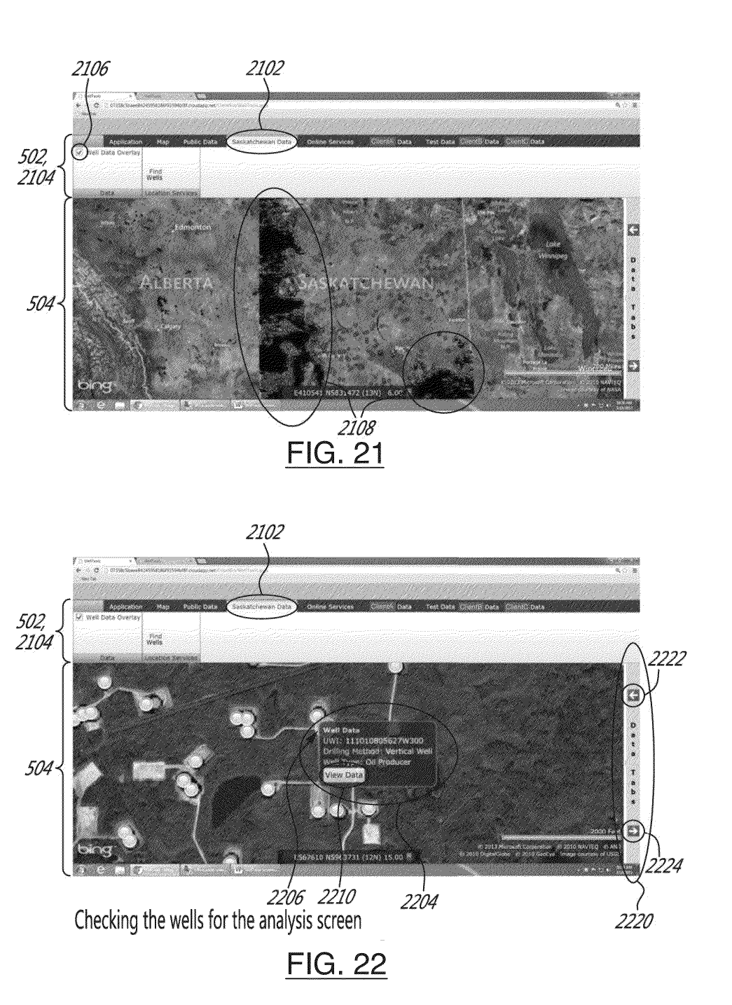

Illustrations of a few of the many possibilities enabled by system(s) 100, 200 in accordance with the invention are shown in FIGS. 21-56. The various Figures illustrate both directly and indirectly a wide variety of uses of map data from map data resource(s) 104, enterprise data from enterprise data resource(s) 106, and analysis tools from any or all of local and/or networked resource(s) 104, 106, 108,

In FIG. 21, a user has accessed a map data resource 104 and caused satellite photo data to be displayed as a geographical map in map window 504. By further selecting interactive GUI element (“tab”) 2102 “Saskatchewan Data”, the user has caused an interactive GUI toolbar 502, 2104 to be displayed. Further, selection of GUI control item 2106 has resulted in display, by means of an overlay process in association with map window 504, of data 2108 representing locations of oil wells drilled in the province of Saskatchewan, the corresponding location data accessed from one or more local and/or remote enterprise data resource(s) 108 “Saskatchewan Data”, using processes such as those described above.

As will be understood by those skilled in the relevant arts, any desired one or more local and/or remote enterprise data resource(s) 108 may be identified through data-based associations between the GUI command item 2102 “Saskatchewan Data” and servers or other digital communications/digital processing devices associated with desired memory(ies) or sources of data. Such resource(s) can, for example, be associated with a command item 2102 through use of hyperlinks, uniform resource locator(s) (URL(s)), and other network address techniques.

In FIG. 22, the user has caused a portion of the map and overlaid data shown at 504 in FIG. 21 to be expanded in scale by a factor of approximately 500 (from a “200 mile” scale to a “200 foot” scale). In addition to showing more precisely, and in greater the detail, a subset of the wells mapped in FIG. 21, processor(s) 102 have caused map window 504 of FIG. 22 to display details 2204 “Well Data” pertaining to a selected one of the mapped wells 2206. As noted above, the display of additional details 2204 by processor(s) 102 can be caused interactively by the user of the system 100, 200, or automatically by processor(s) 102 as a logical function associated with the map “zooming” process. In the embodiment shown, displayed data details 2204 comprise:
A uniquely-identifying serial number: 111010805627W300
A drilling method identifier: “Vertical Well”, indicating that the well is not angled or otherwise directional in nature
A well type identifier: “Oil Producer”, indicating that the well has produced oil.

By selecting interactive GUI control item 2210 “View Data”, a user can access even more detailed information about a selected well 2206. For example, by selecting the “View Data” control item 2210, such user can cause processor(s) 102 of a system 100, 200, to access the same or other local and/or remote enterprise data resource(s) 108 and retrieve, either by reading, downloading, pushing, or any other suitable method, any or all of a very wide variety of informational details associated with a single selected well 2206, or a group of selected wells 2206.

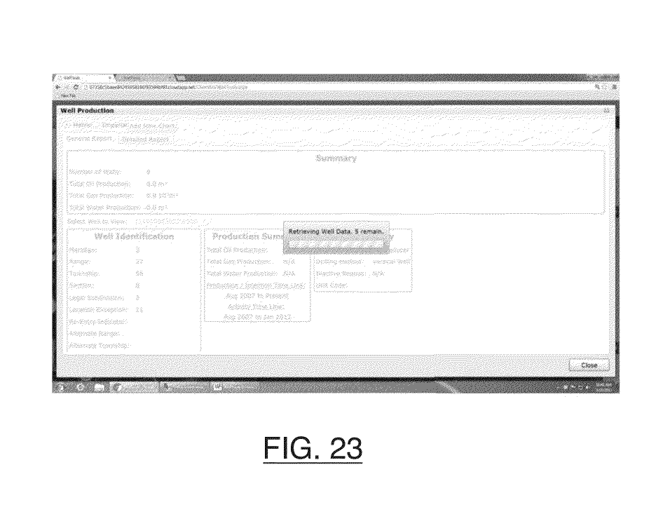

A result of initiating a data request command by selection of command item 2210 is shown in FIGS. 23-25. In the example shown, a command item 2210 has been selected subsequent to prior selection of a plurality of enterprise data items 2206 representing oil well locations. In the example shown, six (6) such well-related data items 2206 have been selected prior to selection of command item 2210, using for example drag-and-drop group selection techniques. Thereupon, one or more enterprise data resource(s) 108 have been accessed, and processor(s) 102 have initiated a process of downloading data representing information associated with the six selected wells. As described herein, the data representing information associated with the selected wells may, in some cases, have been pre-processed by processor(s) 102 to automatically extract data or metadata that processor(s) 102 use to associate the data (contained in more or more data files) with the wells of interest. Thus, when the user sends a data request command to access data on these six wells, the data is already available and does not, for example, need to be manually associated with the six wells prior to accessing.

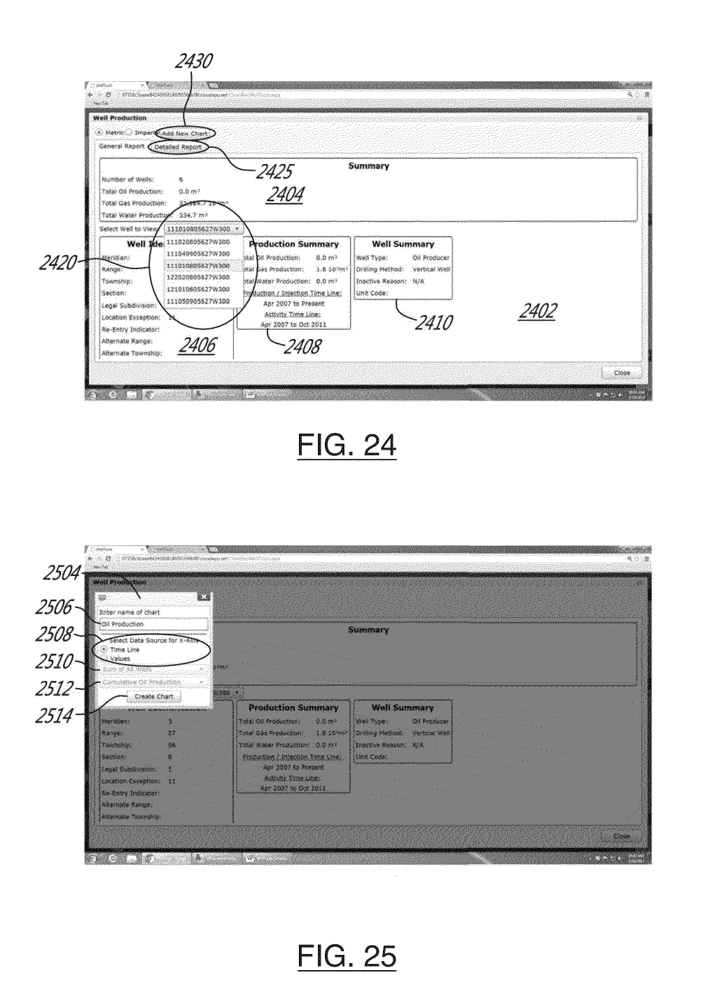

FIG. 24 provides an example 2402 of a display showing information relating to the six wells indicated in FIG. 23, downloaded through use of a command item 2210. Window 2404 provides aggregated data for the six selected wells, pertaining to production of a variety of resources, including oil, (natural) gas, and water. Through use of a drop-down menu command item 2420, the user is enabled to select one of the six selected wells for display of even further detailed information. In the example shown, well No. 11101080505627W300 has been selected in menu 2420; window 2406 provides information pertaining to the geographic and legal location of that well, window 2408 information pertaining to its production of resources, including access to time lines of production history at 2408, and a summary 2410 similar to that provided at 2204 in FIG. 22. Such further information may also, in some cases, have been automatically extracted from one or more data files by processor(s) 102, associated with the wells, and/or organized into a more intuitive form than in the input data files.

In the view 2402 shown in FIG. 24, the user has been presented, by selection or default, with a summary view of production data associated with one or more selected well(s). Through provision of interactive GUI command item 2424, however, the user is also provided with an option of viewing production and/or other information in greater detail.

Thus, for example, a system 100, 200 has provided interactive tool(s) enabling a user to employ an interactive geological map display to navigate to a plurality of individual wells, to access multiple levels of progressively more-detailed enterprise data related to the selected wells from one or more enterprise data resources 108 that need not be related to the map data resource(s) 104 from which the displayed geological map data was acquired, and to display the accessed information in a convenient, flexible, and highly individualized form.

As previously noted, system(s) 100, 200 in accordance with the invention enable even more functionality than indexing or collating of map, enterprise, and geostatistical data. For example, systems according to the invention enable users to interactively access and apply a wide variety of geostatistical, enterprise, and other analytic tools. Examples of such access and use, involving analysis of the production of the Well No. 11101080505627W300 described above, are illustrated with reference to FIGS. 24-28.

In the example illustrated with reference to FIG. 24, as described, a user has entered commands configured to enable review of production information related to Well No. 11101080505627W300, by using menu 2420 as described.

FIG. 25 illustrates a result of selection of an interactive GUI command item 2430 to initiate an enterprise analysis tool adapted to enable the user to create, view, and otherwise process data representing a wide range of charts representing production and optionally other enterprise and/or geostatistical data associated with one or more designated wells, and/or their geographic or geological vicinity. In the example shown, selection of the interactive item 2430 has resulted in presentation of an interactive GUI command element 2504, in the form of a pop-up application interface offering the user a number of interactive options for controlling a variety of charting analysis process. The user is offered, for example, an option 2506 for naming a chart-related data set (as for example by using a keyboard 114 to enter desired alphanumeric characters); an option 2508 for selecting enterprise and/or geostatistical data type(s) for use in generating the chart data; an option 2510 for designating data related to any one or more of a set of wells to be presented on the chart; and at 2512 class(es) of production data to be viewed. When the user has made desired selection(s), selection of command item 2514 causes execution of an a charting analysis algorithm for generating, and optionally displaying and/or saving, data representing a desired chart.

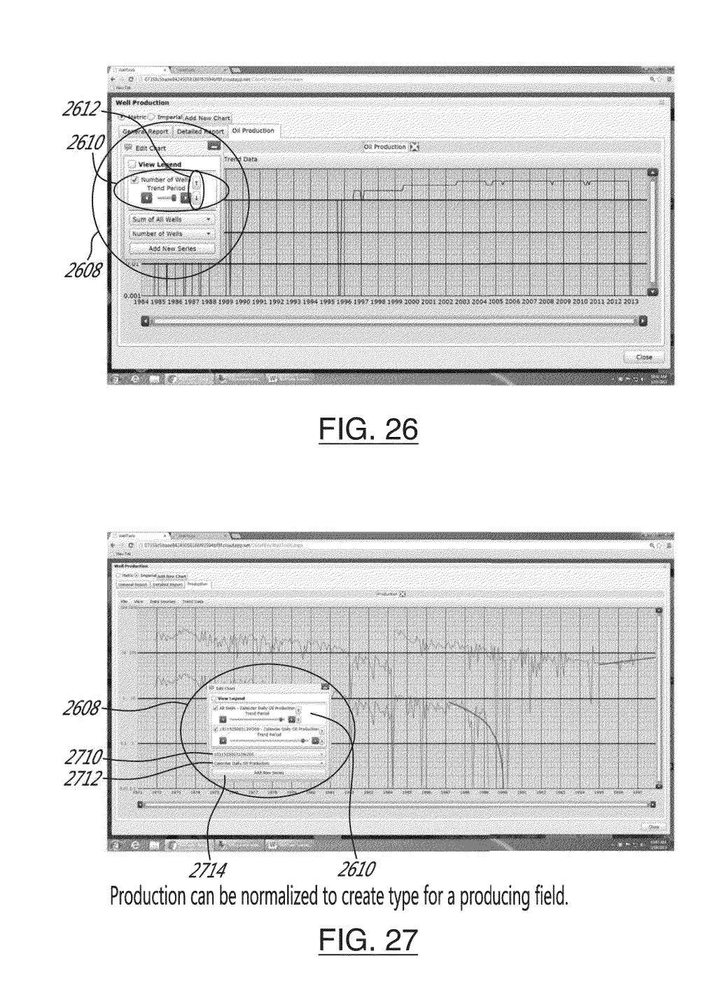

Selection of command item 2514 in FIG. 25 with the selected options shown at 2504 can result in generation of data representing a corresponding chart, and display of such a chart relating, for example, production as a function of time (stated in years) as shown, for example, at 2604 in FIG. 26.

In the example shown in FIG. 26, an interactive GUI command element 2608, has been presented, in the form of a pop-up application interface offering the user a number of interactive options for controlling the current charting analysis process and thereby producing one or more edited charts. In the example embodiment shown, option 2610 enables a user to use interactive command items 2612 to increase or decrease the scale range used in displaying data as a function of time—that is, to show the displayed production data as a matter of years, months, weeks, etc.

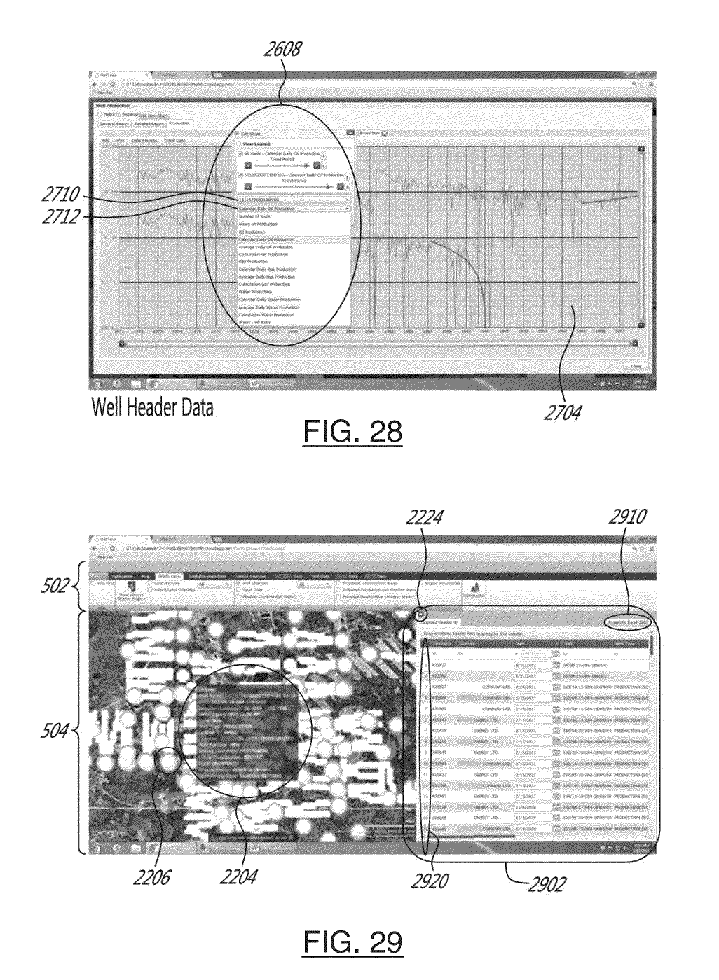

FIG. 27 shows an example of a chart 2704 generated through the use of processes and systems, including GUI command features, as described above. In the example shown, production chart data has been generated and displayed for a plurality of wells, using, for example, an appropriate selection of an item 2512 as shown in FIG. 25. GUI elements 2608, 2610 have been modified to enable corresponding control of data relating to multiple wells. Selection of an interactive GUI command item 2712 “Calendar Daily Oil Production” can result in expansion of the GUI element 2608, with presentation of additional drop-down menus, as shown for example in FIG. 28, with resultant presentation of a wide variety of options for further refinement of analysis process(es) using data accessed and processed for generation of displayed data.

As previously noted, in enabling editing, refining, generating, and (re)-displaying) of modified or extended enterprise and/or geostatistical analysis process(es), as described for example in connection with FIGS. 24-28, processor(s) 102 can access any needed or desired resource(s) 104, 106, 108, etc. any suitable numbers of times, and in any suitable combinations and/or sequences. For example, data used in the original generation of chart or other analysis-related data set(s) can be replaced, added to, or modified by data accessed for generation of later-displayed data sets by gathering all permutation of potentially-desired data at once, having reference to all subsequent analysis possibilities, or it may be accessed as needed, both in terms of time and source, based on user choices in using analysis controls such as GUI elements 2608.

Further options for accessing and implementing enterprise and/or geostatistical analysis tools is shown through reference to FIGS. 22 and 29-30. As previously noted, in FIG. 22 a user has caused display of map data, overlaid with enterprise data. In the embodiment shown in FIG. 22, the enterprise data has, as previously explained, been provided at multiple levels, and optionally from multiple local and/or networked resources 108, and relates not only to locations of individual wells 2206, etc., as displayed, but to identification, drilling method, and type data 2204. Also provided in map window 504 is an interactive GUI command element 2220 “Data Tabs”, which includes command expansion item 2222 and minimization item 2224.

Selection of an expansion item 2222 such as that shown in FIG. 22 can result in display of an “expanded” data window 2902 such as that shown in FIG. 29. Data window 2902 can be configured to display any desired data set(s) relating to any selected or otherwise designated enterprise or geostatistical features, such as a set of one or more wells 2206 or deposits 920, etc. Data of any desired type(s) and/or amount(s), from any one or more resource(s) 104, 106, 108, etc., can be added to or subtracted from the data displayed in window(s) 2902, and any or all such data can be analyzed or otherwise processed in any desired fashion(s).

As one example, a command element 2910 can enable a user to download displayed data sets to other programs, databases, or applications, such as for example a Microsoft™ Excel spreadsheet.

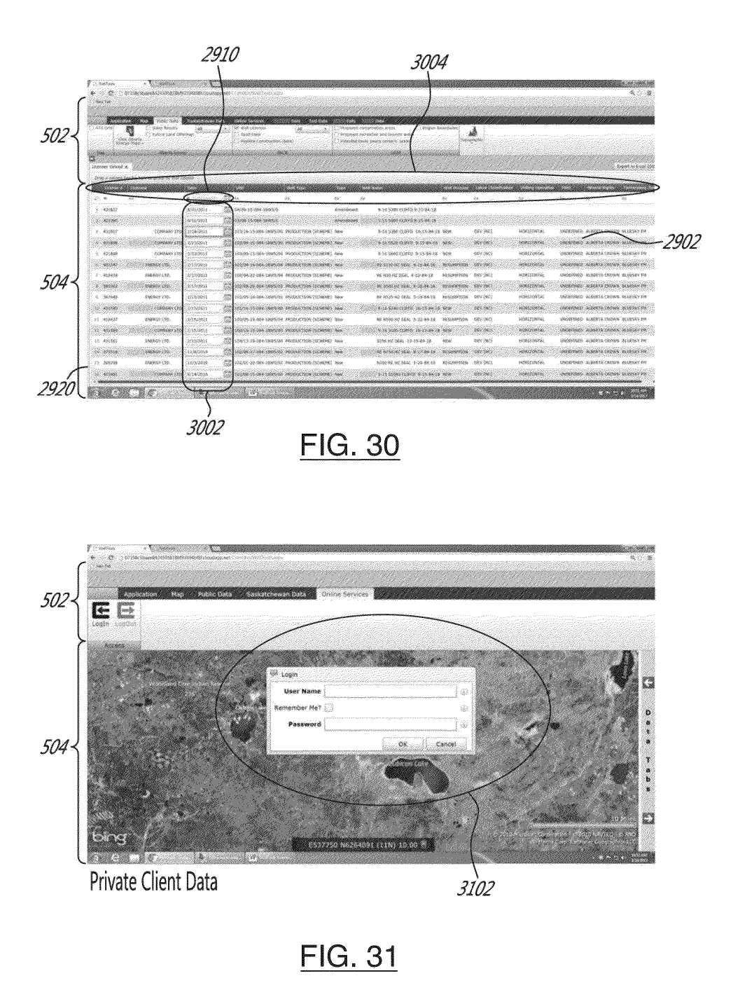

Amounts of data displayed in a window 2902 can further be controlled by, for example, expanding or contracting any or all of the boundaries associated with the window. For example, using a pointing and selection device such as a mouse or trackball can enable a user of a system 100, 200 to “drag” an edge 2920 of the window 2902 so that it covers a larger portion, or all, of the map window 504, as shown for example in FIG. 30.

Different analysis(es), or extension or modification of existing or ongoing analyses, may be facilitated through provision of GUI command devices such as drop-down menus 3002, 2910, command item(s) 3004, etc.

FIG. 19 illustrates a GUI 500, 1900 adapted for association of geostatistical data with displayed map data 504. In the embodiment shown, a GUI element 1902 has been selected, with further selection of a GUI command item 1904, which has resulted in generation and display of a GUI command element 1906, in the form of a drop-down menu adapted to enable access to both enterprise and geostatistical data, including specifically enterprise data pertaining to mineral ownership in Alberta and geostatistical data pertaining to the location of oil deposits in Alberta and a separate map of oil reserves.

As will already have been appreciated by those skilled in the relevant arts, any or all map, enterprise, and geostatistical data resources 104, 106, 108 may provide data related to any or all three categories. Thus, for example, a single server, memory, or other resource might serve the functions of any one or more of map, enterprise, and geostatistical data resource(s) 104, 106, 108.

As previously noted, data used by processor(s) 102 in the various process(es) described herein can be provided by any combination(s) of public or private data resource(s) 104, 106, 108. Access to data controlled by or otherwise associated with resource(s) 104, 106, 108 can be controlled by any suitable means. For example, access to such a private resource(s) can be controlled through the use of firewalls, username/password combinations, biometrics, and/or any other form of security suitable for the purpose.

An example of an interactive GUI command element 3102 for controlling access to privately controlled enterprise and geostatistical resources 106, 108 through the use of user i.d.s and passwords is shown in FIG. 31. As an example, a user's display 112 can be provided with such an element in order to establish authority to access and use data in any previously-defined set(s) of locally and/or remotely controlled data resource(s) 104, 106, 108 of a system 100, 200 as shown in FIGS. 1 and/or 2.

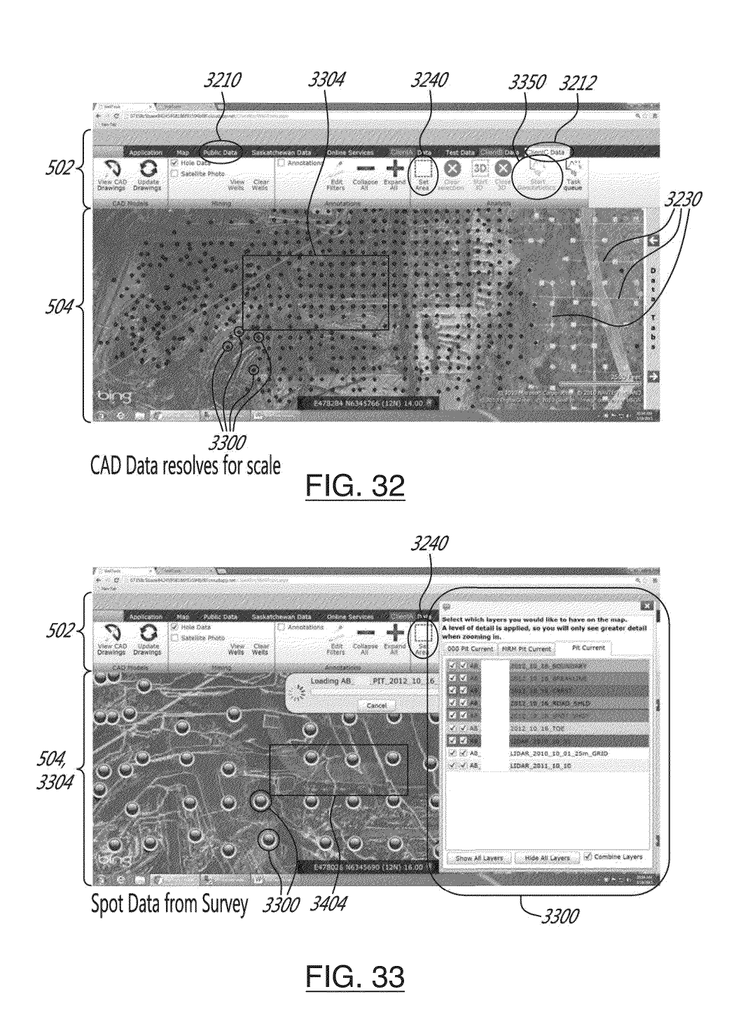

Examples of further functional possibilities enabled by system(s) 100, 200 and suitable for implementation using, for example, process 300 of FIG. 3, are shown and described in relation to FIG. 32 et seq.

In the embodiment shown in FIG. 32, a publicly-available, remotely-networked, continually-updated map data resource 104 has been accessed, and a geographical surface map generated using composite satellite photographic imagery has been generated and displayed in a map window 504.

The map data displayed at 504 in FIG. 32 has been opaquely overlaid with displayed data representing enterprise data representing a plurality of dozens of oil and/or gas well locations 3300. Such overlaid enterprise data has been accessed from a publicly-available government-provided networked enterprise data resource 108 associated with GUI command item 3210 “Public Data”.

The map data displayed at 504 in FIG. 32 has also been translucently overlaid, using enterprise data 3230 representing pipelines and associated fittings and components, accessed from a private enterprise data resource 108 associated with GUI command item 3212 “ClientB Data,” which data has been accessed through the use, for example, of a data security GUI element 3102 as shown in FIG. 31.

The process of accessing and correlating map and enterprise data representing the surface of the earth, well locations, and pipeline installations, drawn from different data sources 104, 108, so that it may be displayed in coherent and intelligible fashion for analysis, during the generation of data for display in FIG. 33, is consistent with process steps 306, 308 of FIG. 3 described above.

In the example shown in FIG. 33, a portion 3304 of the map display 504 shown in FIG. 32 has been enlarged for display in window 504, 3304, using point-and-select input device(s) 114 and interactive GUI element 3240 of tool bar element 502, the element 3240 being associated with a “set area” tool configured to enable to enable a user to select and enlarge an area in the manner shown.

In addition to selection and enlargement of the map portion 3304, the user has selected interactive GUI element 3350 of tool bar element 502, and thereby initiated access to a geostatistical analysis tool, with resultant display of a GUI control element 3300 that enables access to a variety of geostatistical data associated with the mapped region 504, 3304. In the example shown, GUI analysis control feature 3300 enables access to, and display and other processing of, subsurface geostatistical data associated with the a bitumen deposit in Alberta, specifically in the geographic region shown in map display 504. In the embodiment shown, a user is enabled to interactively select for display data representing geostatistical data associated with one or more subsurface layers of the bitumen deposit.

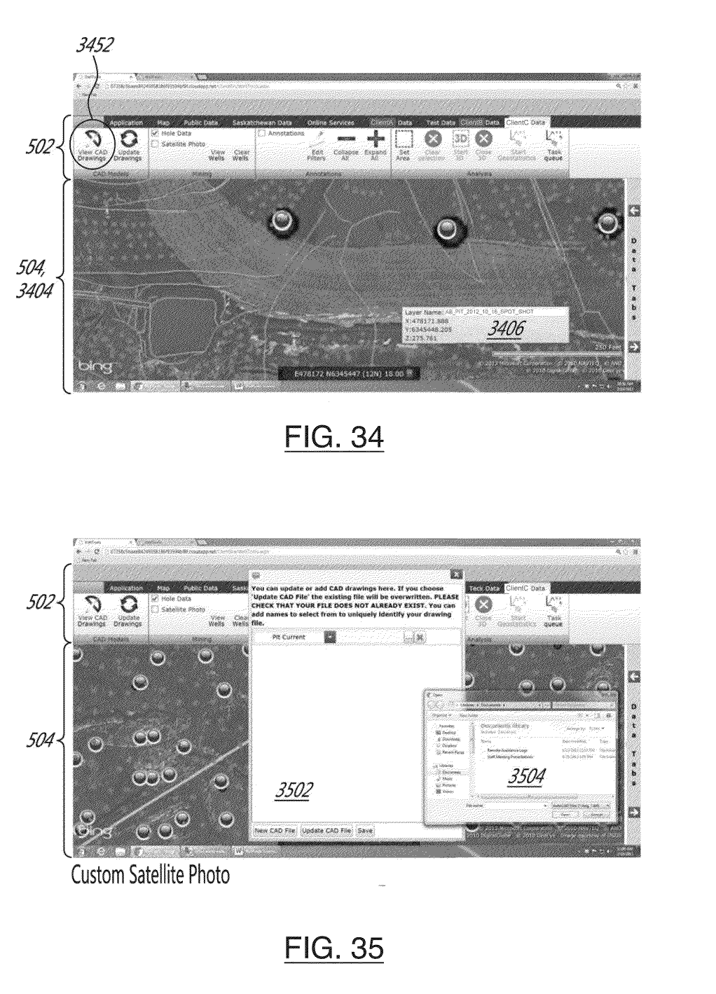

In FIG. 34, a section 3404 selected from the display 3304 of FIG. 33 is displayed, with a translucent overlay of deposits associated with a layer “AB_PIT_{—}2012_{—}10_{—}16_SPOT_SHOT”, and associated data in a graphical overlay element 3406.

The process of accessing and correlating map, enterprise, and geostatistical data drawn from different data sources 104, 106, 108, so that it may be displayed in coherent and intelligible fashion for analysis, during the generation of data for display in FIG. 33, and then in FIG. 34, is consistent with process steps 310, 312 of FIG. 3.

In FIG. 35, a means for returning from a process 310, 312 of accessing and displaying geostatistical data which has already been overlaid with enterprise and map data, to a process 304, 306 of accessing, displaying, and/or otherwise processing further enterprise data is described with reference to FIGS. 34 and 35.

In FIG. 34, a user can select an interactive GUI control element 3452 of tool bar 502 to invoke a configured for accessing, creating and/or otherwise processing enterprise data generated by, or otherwise associated with, computer-aided design (CAD) processes. Selection of such an element 3452 can, for example, result in display of an interactive GUI control feature 3502 adapted to allow a user to access, generate, or otherwise manipulate one or more CAD data sets representing drawing engineering or other drawings, as shown in FIG. 35. Selection of any of the various control items can result in presentation of a web- or system-browser element 3504 adapted to enable a user to navigate to, and select, one or more CAD drawings for display or other processing.

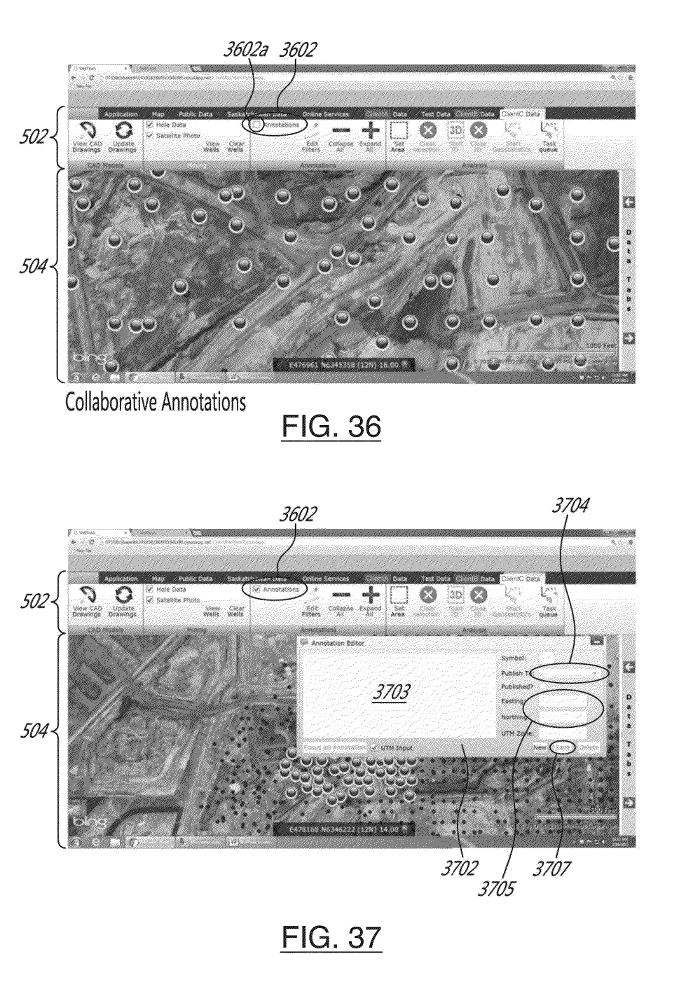

In various embodiments, systems 100, 200 and processes in accordance with the invention provide tools for enabling shared, or collaborative, annotations which may be associated with specific geographic locations, specific enterprise installations, and/or specific geostatistical information data sets. For example, as shown in FIG. 36, an interactive GUI control item 3602 “Annotation” may be provided in a tool bar 502. Selection of a ‘check box’ item 3602a can cause a GUI feature 3702 “Annotation Editor” to be displayed, as shown in FIG. 37, with any desired one or more input fields adapted, for example, of keyboard, cut and paste, and/or drag and drop entry of text, images, video, etc, as shown at 3703; absolute and/or relative geographic location(s) as shown at 3705; and optionally other data. Annotations and other information entered in the GUI input device 3702 can be stored in any one or more desired memories 104, 106, 108, etc. by selection of a command item 3707 “Save,” and associated by one or more processor(s) 102 with the geographic location, designated enterprise or geostatistical feature, etc., and thereafter accessed, viewed, modified, and/or otherwise processed, not only by the user that entered the data, but by other users designated by the originating user. For example, by selecting a drop down menu through use of a GUI element 3704, or otherwise making suitable designations, such a user may associate URL or other address or identification information with specific individuals or groups of individuals, or with authorized enterprises or entities.

Thereafter, when a second or subsequent user associated with suitable authorizations accesses relevant portions of the corresponding map, enterprise, and/or geostatistical data, such user may be presented with a corresponding item displaying the data entered at 3702, or otherwise enabling access to it, and may add to, revise, delete, or otherwise modify the stored annotated data.

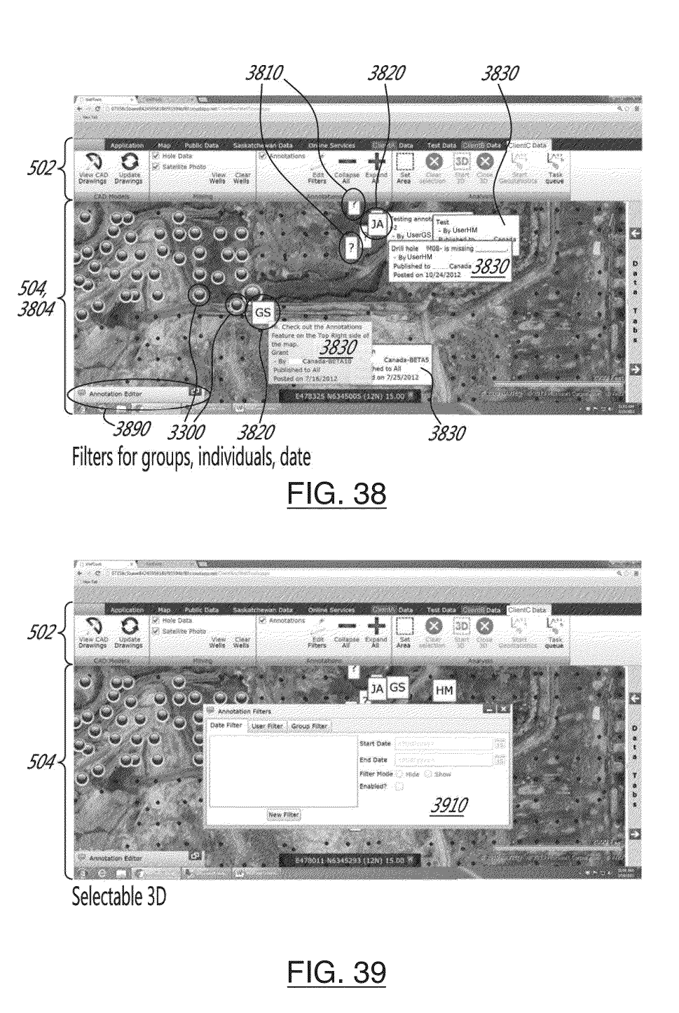

For example, a user of a suitably-configured geological analysis system 100, 200 operated by, for example, an enterprise using a secure server to host processor(s) 102, and one or more enterprise data resource(s) 108, can access such secure enterprise system 100, 200 by entering suitable authorization credentials, such as an authorized user name and password at an GUI authentication element 3102 of FIG. 31. Using processes such as those described in connection with FIG. 3, such authorized user can then navigate to a map region 504 showing associated enterprise data, as shown for example in FIG. 38. The display 504, 3804 thus presented can include one or more annotations 3810, 3820, 3830 associated with specific locations, installations, or deposits represented on the displayed map section.

As shown in FIG. 38 annotations 3810, 3820, 3830 associated with such locations, etc., can be presented in a variety of forms, depending upon factors such as the authorization-level of and level of inquiry instituted by the viewing user. For example, an enterprise may comprise multiple sets of users, such as employees assigned to differing tasks, having different management or administrative responsibilities, etc.; and/or an enterprise may be consist of two or more business entities, operating as affiliates, venture partners, etc. In such cases, a user authorized to access one or more enterprise data resources 108 may not be authorized to view all data stored thereon, or otherwise associated therewith. In such cases, a user navigating to a map/enterprise display 504, 3804 such as shown in FIG. 38 may see at least three types or levels of associated annotations.

A first type or level of annotation 3810 may indicate that an annotation associated with a location, installation, etc., in the vicinity of its presentation on the map 504 exists, but is not currently accessible by the user, either because the user lacks suitable authorization, the data is corrupt or incompatible with the user's operating system, etc. Such user-inaccessible annotations may be denoted by any suitable indicia, including for example a mark of interrogation, as shown.

Among annotations a user is authorized to access, a first type or level of 3820 can include an abbreviated indication related to the content or source of the annotation, indicating for example an author or source, a type or class of annotation, etc., that the user is authorized to access. This can impart significant information to the viewing user without unduly cluttering the display 504, 3804.

A third type or level of annotation 3830 can include further details of content associated with the annotation, and can for example include hyperlinks or other pointers or references to even further details, analysis tools, etc.

As will be appreciated by those skilled in the relevant arts, any desired numbers or types, levels, and/or contents can be associated with annotations 3810, 3820, 3830, etc.

A further advantageous feature of annotations in accordance with the invention is the ability to filter the types, number or content of those which are displayed. For example, as shown in FIG. 39, a user can access an interactive GUI feature 3910 “Annotation Filters” and limit the presentation of filters 3810, 3820, 3830 by dates or date ranges; authors, editors, or other user(s); author, editor, engineering team, or other authorized group(s); and/or by any other characteristic(s) associated with the annotations. As shown at 3920, filters can be used to hide classes of filters, or to cause them to be displayed; and filter criteria can be edited or changed at any time. As will be understood by those skilled in the relevant arts, filters can be created, edited, and applied using any suitable data processing techniques, including a wide variety of database management techniques.

Thus, for example, in various embodiments the invention provides geological analysis tools comprising one or more processors 102 configured to send to a system 100, 200 associated with a first client, signals useful for displaying a geological map comprising indicia 3300, 3230, 3304 representing geostatistical information associated with at least one location on the surface of the earth; in response to receiving, from the system 100, 200 associated with the first client, annotation data associated with one or more geographical locations, enterprise installations, and/or geostatistical considerations; store the annotation data; and send to a system 100, 200 associated with a second client, signals useful for displaying a geological map including an annotation associated with the displayed map and based at least partly on the annotation data.

Among the many improvements offered by the invention is the ability to build, using data accessed from widely different types and classes of data, stored in widely different types and classes local and/or networked resources, three-dimensional (3-D) models of the earth, showing and otherwise associated with all types and classes of geological, enterprise, and geostatistical data. Such models may be used to enable the application of a wide variety of locally and/or remotely stored analytical tools to any or all data associated with the models, for example to apply locally and/or remotely stored algorithms to the data and thereby generate, display, store, and/or otherwise further process any suitable type(s) of data.

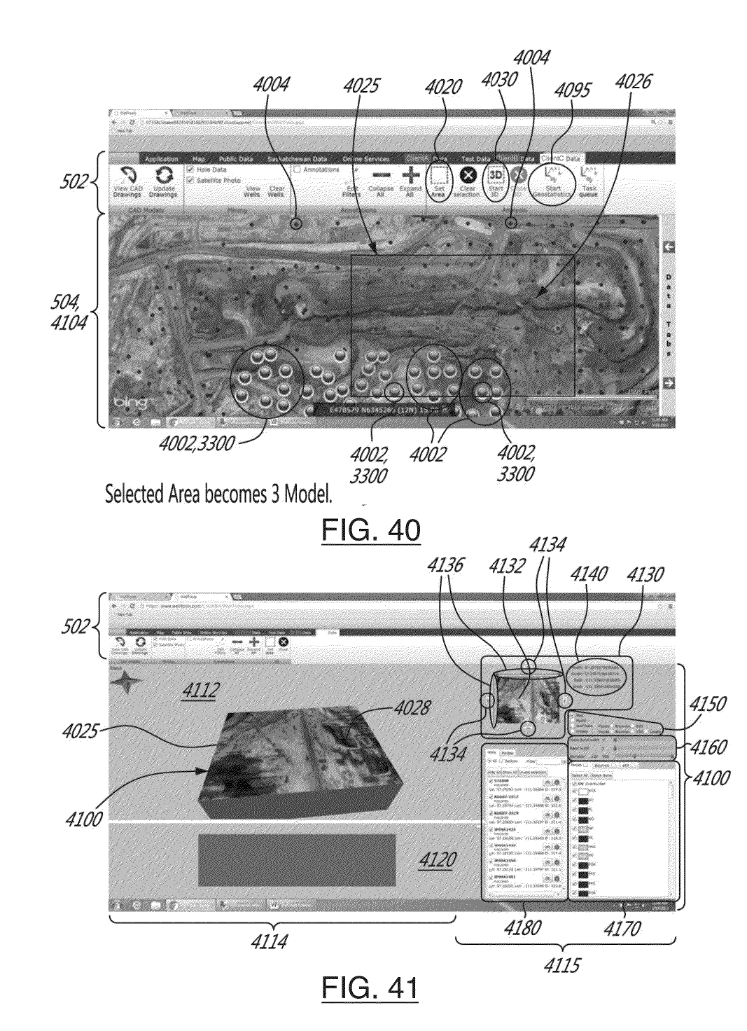

An embodiment of such a 3-D modeling and analysis tool is described in connection with FIGS. 40-47.

In FIG. 40, a user has accessed a geostatistical analysis tool 100, 200 to generate and display a map window 504 comprising a satellite photo-based geological surface map overlaid with enterprise data representing a number of well and bore locations 4002, 4004. The user has further defined a region of the mapped area for 3-D geological/geostatistical modeling, by selecting interactive GUI element 4020 “Set Area”, and thereafter using a point-and-select input device 114 to designate the bounds 4025 of the area 4028 the user wishes to analyze.

By selecting a GUI control element 4030 “Start 3D”, the user can cause processor(s) 102 to initiate a 3-D modeling state, or mode, and generate a 3-D display window 4100 showing a 3-D volume of earth 4110, an upper face of which comprises the selected area 4028 of the map 504, 4004, the sides 4113 and bottom of which may be defined using default values until determined by further user action.

In the embodiment shown in FIG. 41, 3-D display window comprises image display regions 4114 and interactive control regions 4115.

In the embodiment shown in FIG. 41, image display portions 4114 of 3-D display window 4100 comprises a 3-D viewing and volume manipulation region 4112, and a 2-D surface viewing pane 4120. 3-D viewing and manipulation pane 4112 provides a 2-D projection of the volume 4110, in an orientation that is fully controllable by the user, using any suitable 3-D image control technique(s). 2-D viewing pane 4120 enables a user to view a cross section of the rectangular volume 4110.

Interactive data control portion 4115 enables a user to control display and other processing of any available map, enterprise, and/or geostatistical data associated with the region 4028 used in defining the volume 4110. In generating the interactive control portion 4115, processor(s) 102 can poll all available map, enterprise, and geostatistical resources 104, 106, 108, and determine what data of each type associated with selected volume 4110 is available for use in generating displays and optionally for further processing. Having determined what data is available, the processor(s) 102 can generate interactive control elements such as elements 4130, 4150, 4160, 4170, 4180 shown in FIG. 41. Such element(s) 4130, 4150, 4160, 4170, 4180, and/or other GUI control elements suited to a desired analysis can be tailored specifically to both the nature of analysis desired by a user, the volume of earth 4110 defined by the user, and the type(s) and amount(s) of relevant map, enterprise, and geostatistical data available.

In generating GUI control element 4130 in the embodiment shown in FIG. 41, processor(s) 102 have determined that enterprise data relating to well bores, and geostatistical data relating to facies, bitumen deposits and D50 is available in data resources 106, 108, and therefore have provided interactive checkbox-type control items configured to enable a user to select or de-select those types of data for display and optionally further processing.

In the embodiment shown in FIG. 41, window 4100 further comprises interactive GUI control element 4130, which enables control of bounds 4025 of the volume 4110. Element 4130 shows a topographical map 4132 of the volume 4110, corresponding to the area 4025 within bounds 4025 set by the user in window 504, 4004 of FIG. 40. GUI control element 4130 further comprises control items 4134 and 4136 which enable a user of a point-and-select device to adjust or alter bounds 4025 of the selected volume 4110 independently for various display elements and without returning to a 2-D tool such as that provided in conjunction with display 4004 and GUI elements 4020, 4030 of FIG. 40. Display 4100 and/or GUI element 4130 further comprises display region 4140 showing geological data defining bounds 4025 of the defined volume 4110.

In the embodiment shown, GUI control element 4160 enables a user of a point-and-select tool 114 to independently select depths of earth, wells, and other elements to be shown in and/or otherwise processed in association with volume 4110.

In the embodiment shown in FIG. 41, 3-D modeling tool window 4100 further comprises interactive GUI control elements 4150, 4170, 4180 for use in controlling map, enterprise, and/or geostatistical data to be associated with the modeled volume 4110, and thereby for use in generating data useful for displaying the volume 4110, and optionally for further processing.

As noted above, each of elements 4150, 4170, 4180 can be dynamically defined by processor(s) 102 controlling the 3-D modeling tool, so as to provide both indicia indicating the types of geostatistical data associated with the volume 4110 that are available via resources 104, 106, 108 accessible by the system 110, 100.

GUI control element 4150 is configured to enable a user to select which set(s) of available map, enterprise, and/or geostatistical data is to be displayed and optionally further processed. In the embodiment shown in FIG. 41, processor(s) 102 have determined that enterprise data relating to wellbores, and geostatistical data relating to facies, bitumen deposits, hydrocarbon saturations, porosity, permeability, and particle size distributions, D50 is available in data resources 106, 108, and therefore have provided interactive checkbox-type control items configured to enable a user to select or de-select those types of data for display and optionally further processing.

In generating the display and interactive elements comprised by GUI control element 4170 shown in FIG. 41, processor(s) 102 have polled all available local and/or networked, public and/or private map, enterprise, and geostatistical resources 104, 106, 108, and determined that at least 13 types of deposits may be present within the displayed volume 4110, and have therefore generated interactive checkbox-type control items configured to enable a user to select or de-select data relating to each of those types of data for display and optionally further processing.

In generating GUI control element 4180, processor(s) 102 have identified the wells and wellbores, probes, or other bores within the region 4028 defined by bounds 4025 in FIG. 40. Processor(s) 102 have further used such identifications to generate interactive lists of all such wells and probes, and provided interactive checkbox elements to enable a user to designate which of such wells and/or probes the user wishes to include in display and other processing in association with the volume 4110 shown at pane 4112.

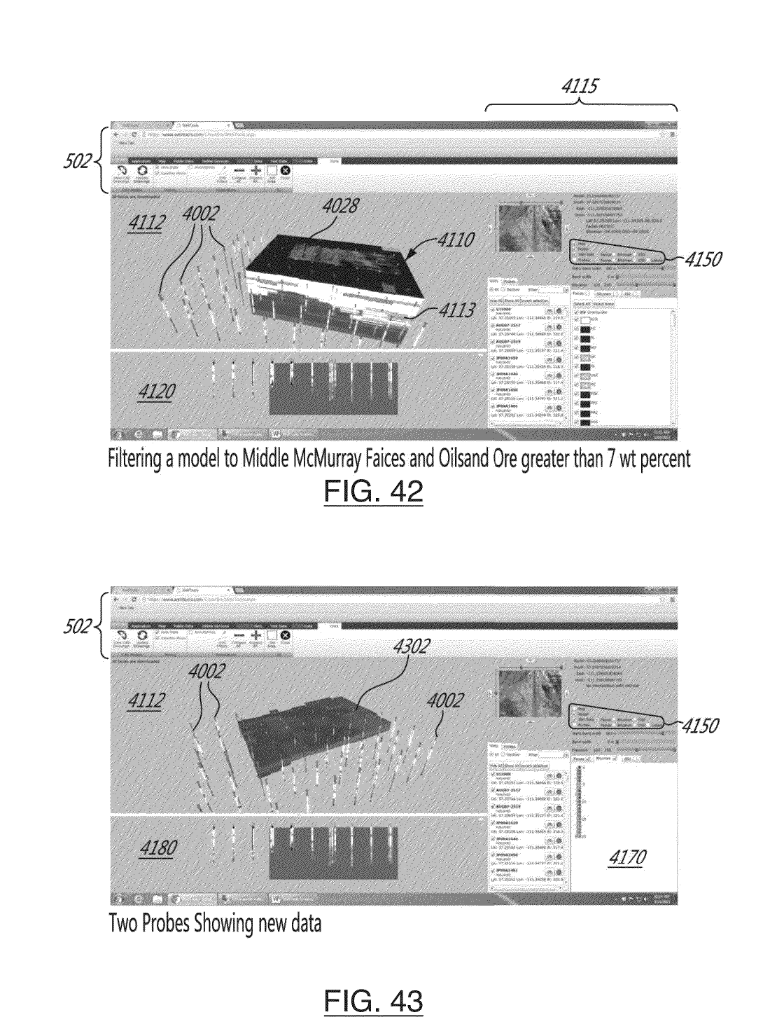

Having used suitably-configured GUI commands to select a desired projection for display of the volume 4110, and desired types or sets of map, enterprise, and/or geostatistical data to be displayed in association with the volume 4110, a user can cause processor(s) 102 to refresh pane 4112 to by generating and displaying corresponding image data, as for example shown in FIG. 42. It may be seen in the example shown in FIG. 42 that any or all of map, enterprise, and geostatistical data (sub)sets selectable at GUI element 4150 may selected and displayed independently of each other, but in common, coordinated orientation. For example, as shown in FIG. 42, oil wells 4002 are displayed outside the selected bounds of volume 4110, and map region 4028 does not cover all of the surface of the volume 4110.

In FIG. 43, it may be seen that de-selection of “map” checkbox in GUI control element 4150, and selection of an item “bitumen” in GUI control element 4170, can result in display of only bitumen deposits 4302 having bitumen content of more than 7% by weight within the defined volume 4110, in combination with selected well enterprise data 4002.

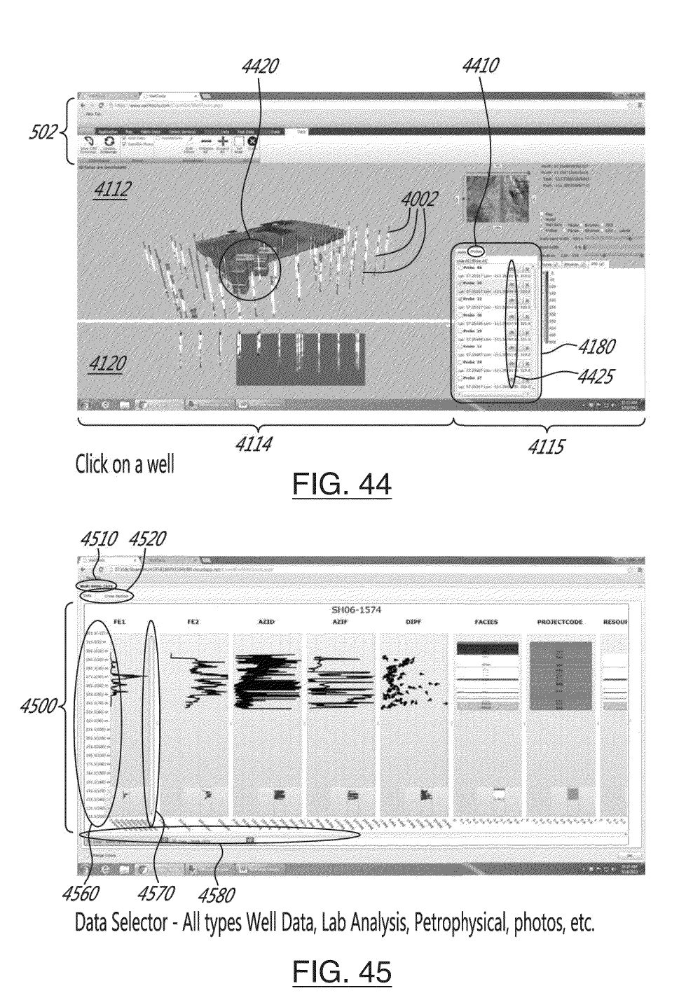

Selection of GUI control element 4410 “Probes”, and one or more probes identified on the resulting interactive list, can result in display of geostatistical data associated with the selected probe(s), as shown for example at 4420 in FIG. 44. Such data can, for example, represent geological deposits known to be present as a result of probe activity conducted at the corresponding locations, and can be extrapolated through user-defined or determined default volumes for display purposes, as shown in FIG. 44.

It will be apparent to those skilled in the relevant arts, once they have been made familiar with this disclosure, that various type(s) and class(es) of geological deposits and/or other data displayed or otherwise represented in various portions of window regions 4114, 4115 may be shown in any desired or otherwise suitable distinguishing fashion, as for example by showing different deposits in different colors—e.g., varying shades of black/gray for bitumen, beige for sand, blue for water, etc.

In addition to allowing immediate and detailed visualizations, from any desired angles, of any desired combinations of data relating to any desired volumes of earth, systems 100, 220 in accordance with the invention enable immediate access to extremely detailed information relating to a very large number and variety of geological, enterprise, and/or geostatistical features, using any of a number of very convenient GUI control element access points.

For example, it has already been explained that selection of either or both of images 4002 displayed in pane(s) 4112, and GUI checkbox elements in GUI control elements 4180, can be used to select any one or more desired probe data sets for display of associated geostatistical data in the form of 3-D graphical image elements 4420. That is, images such as well or bore images 4002, can themselves, through the use of hyperlinks and other process-initiating techniques, be used as means for accessing data related to the wells or bores displayed.

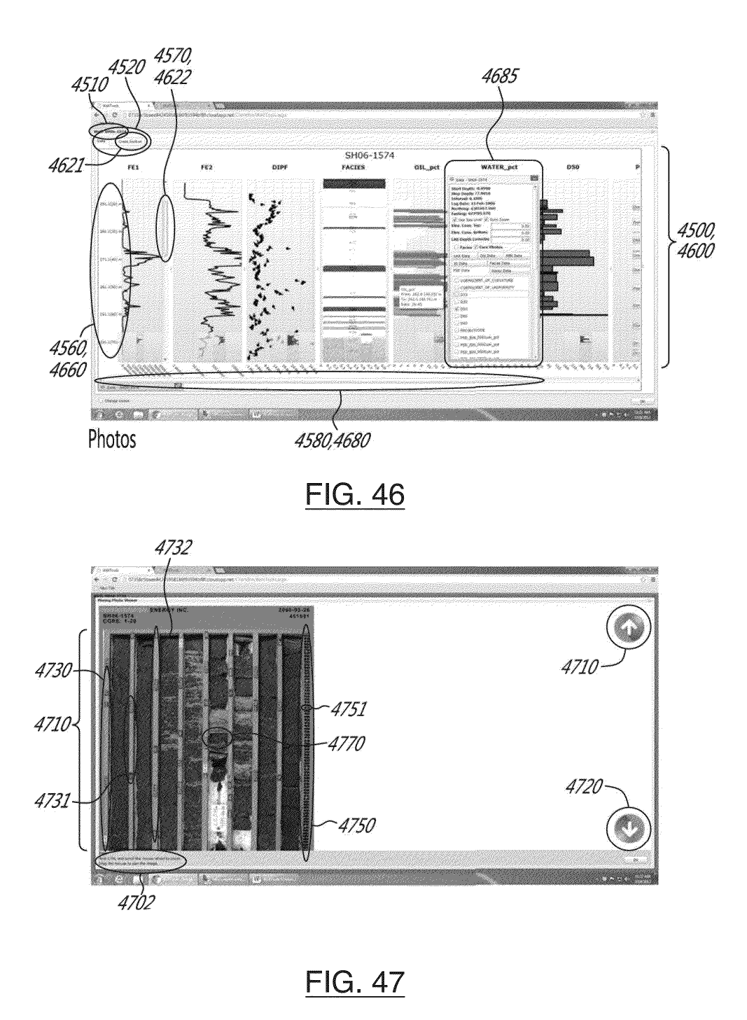

As a further example, selection of either or both of images 4002 displayed in pane(s) 4112 and GUI checkbox elements in GUI control elements 4180 can be used to initiate display of a great deal of associated geostatistical data in a new or added GUI window, such as that shown at 4500 in FIGS. 45 and 46.

Window 4500 of FIGS. 45 and 46 provides an example of the amount and variety of data associated with a well, bore, or other enterprise or geological or geostatistical feature that may be accessed from one or many local and/or networked data resources 104, 106, 108, aggregated, collated, indexed according to any one or more convenient parameters, and displayed for user review and/or further processed using any desired analytical tool(s). In the example(s) shown, geostatistical data representing a number of characteristics and associated with a selected well “SH06-1574” has been accessed from a variety of public and private resources 106, 108, and displayed in chart form, as a function of well depth, correlated so that the vertical (“y”) axes are indexed according to common scales 4560, 4660. In order to facilitate rapid and convenient access to data, various types of GUI control items, such as scroll bar(s) 4570, 4580, may be provided.

As previously noted, a wide variety of data may be available from resources 104, 106, 108; among the advantages offered by the invention is the aggregation, correlation, sorting, and display of such data in a common format, so that reviewing all data, and reviewing desired details of various types of data is greatly simplified. Moreover, the invention enables the rapid and convenient modification of display(s) 4500, such that users can rapidly and conveniently focus on data of interest, and, if desired, implement further processing of data of interest, using printing, storage, and analytic tools as desired.

For example, it may be noted that in window 4500 of FIG. 45, most displayed data of interest is associated with well depths between 301 meters and 241 meters. Use of any suitable GUI control features such as drop-down menus, various keystroke/control inputs may be used (a) to select subsets of available data types and (b) ranges of specific interest.

Thus, for example, in progressing from display 4500 of FIG. 45 to a more specific display 4500, 4600 of FIG. 46, a user may access an overlay (“pop-up”) menu 4685 or other GUI control feature to enter suitably-configured input commands and thereby shift from display of data types 4590 “FE1, FE2, AZID, AZIF, DIPF, FACIES, PROJECT CODE, RESOURCE” (and others not currently displayed, as indicated by scroll bar 4580) to data types 4590, 4690 “FE1, FE2, DIPF, FACIES, OIL_pct, WATER pct, D50” (and others, as indicated by scroll bar 4580, 4680).

Moreover, by using the same or any other desired GUI input means, the user may cause common depth scale (or “y” axis) 4560 to expand as shown by scale 4660 and scroll bar 4622, so that data of interest may be spread out over a larger portion of the data display 4500.

Although not visible in FIG. 45 or 46, in some examples, window 4500 can display well core/bore images in alignment with the geostatistical information as a function of well depth. The well core/bore images can be displayed as a series of images at different depths or as a single composite image.

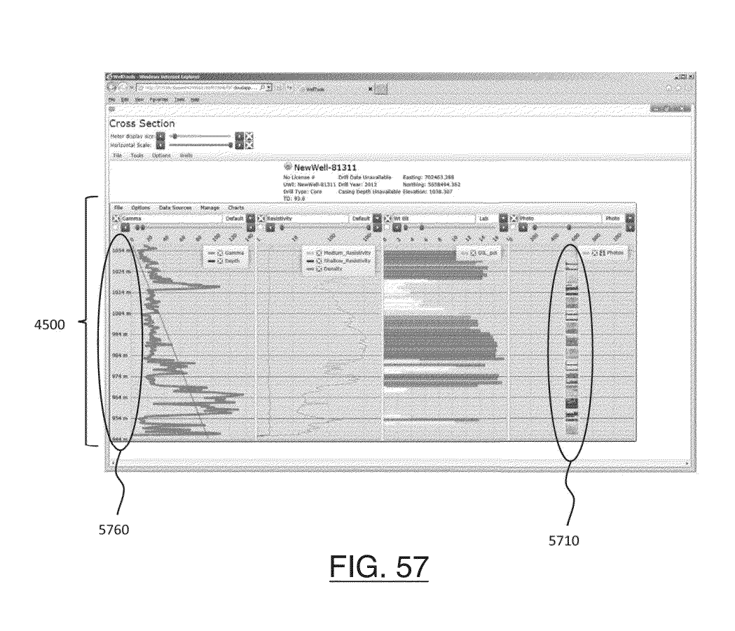

For example, window 4500 of FIG. 57 provides an example of geostatistical data accessed from one or many local and/or networked data resources 104, 106, 108 and displayed in alignment with well core images 5710. In the example shown, the geostatistical data includes Gamma, Resistivity, Wt Bit and well core image data for a selected well “NewWell-81311”. The data is displayed in chart form, as a function of well depth, correlated so that the vertical (“y”) axes are indexed according to common scale 5760.

As previously noted, among the many advantages offered by the invention is the association of various forms of data pertaining to geological and enterprise features of interest, such as wells, mines, pipelines, mineral deposits and water, and the scaling, indexing, or other collation of such data so that it may be overlaid or otherwise displayed in common with map, or other geostatistical or enterprise data. One example of this feature is that aforementioned display of map images with overlaid indicia representing enterprise and/or geostatistical information. A further example, which in many circumstances may offer particular advantage for the review, analysis, and/or other processing of geological formations is the association of photographic and other image data representing the inside of wells, mines, and other excavations, and/or core samples or other material removed from such excavations.

A particularly advantageous embodiment of such associations is the creation of composite wellbore images and their scaled display, alongside or otherwise in correlation with geostatistical data such as facies or other geostatistical data. An example is shown in FIG. 47. In FIG. 47 a series 4710 of section views of the interior of the wellbore SH06-1574, provided by an enterprise and/or geostatistical data resource 106, 108 “Energy Inc.”, has been used to generate a composite image of the wellbore through a great range of depths, as shown. Geostatistical data 4730, 4731, 4732, etc., in the form of facies and/or deposit information is also provided, along vertical (“y” axes) corresponding to the bore depths at which the images were captured.

At 4750, a complete set of composite bore images for the wellbore SH06-1574 along the entire range of depths of the available wellbore image data is provided. Each of the “thumbnail” composite images 4751 is a selectable GUI command item, selection of which can for example cause regeneration and re-display of the scaled image display 4710, centered on the selected image 4751.

Moreover, selection of a portion 4770 of composite image 4710 can cause processor(s) 102 to retrieve or create and display a full-resolution image, which may be a composite of two or more discrete images accessed at resource(s) 106, 108, of the corresponding location.

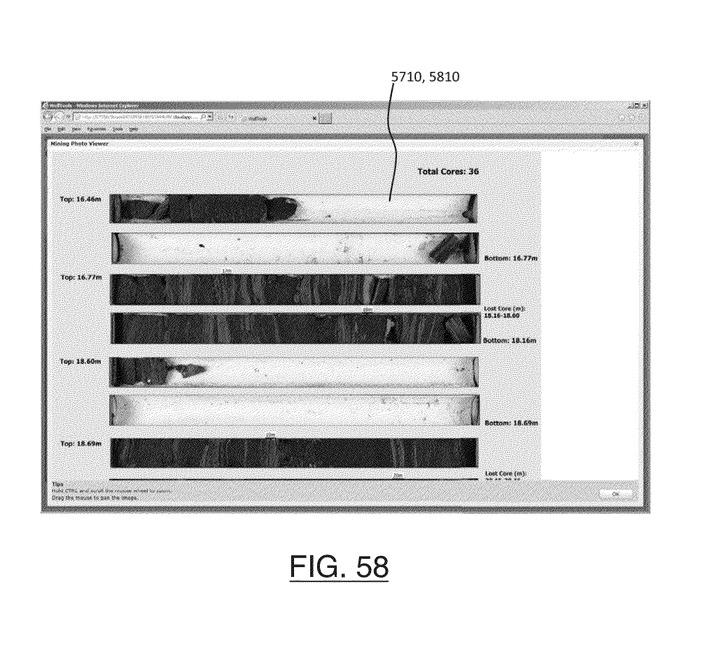

FIG. 58 shows an example of a series of full-resolution core images 5810. As described above, one or more of these full-resolution images can be displayed when a user designates one or more thumbnails or a portion of a composite image. In FIG. 58, the images represent cores oriented horizontally with the upper end (shallower depth) of the core positioned on the left and the lower end (deeper depth) on the right.

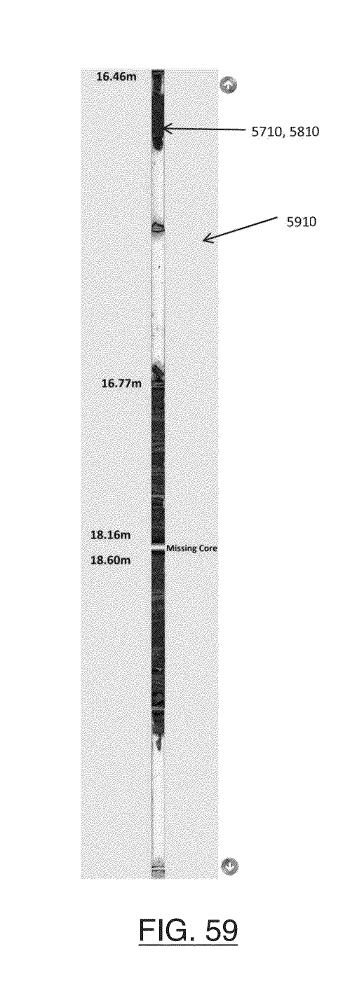

In FIG. 59, the core images 5810 of FIG. 58 have been rotated and aligned end-to-end to display a composite image 5910 of the well bore. The composite 5910 image can be scaled, sized, or otherwise processed to fit in a desired window or space. In some examples, a portion of this image can be selected to display a more detailed, enlarged or full-resolution image of the selected portion.

At any or all resolutions, images of such enterprise and/or geostatistical features may be associated with any desired enterprise, geostatistical, and/or geological data for display and optionally other processing.

Thus, in various embodiments, the invention provides geological analysis tools 100, 200 comprising one or more processors 102 configured to, in response to signals representing a command to display well bore image data, access data representing a plurality of images of at least a portion of an interior surface of a well bore or other geological or enterprise feature; using the accessed image data, generate signals useful for displaying on a display device a composite image representing at least a portion of the plurality of images, the generated signals configured to scale the displayed composite image to fit a predetermined portion of a display screen; and in response to signals representing a user designation of a portion of the displayed composite image, generate signals useful for displaying on a display device an enlarged view of the designated portion.

The invention further provides such tools 100, 200 wherein the one or more processors 102 are configured to access subsurface geostatistical data associated with the well bore, and the generated signals configured to scale the displayed composite image to fit a predetermined portion of a display screen are configured to display the composite image in alignment with geostatistical information associated with the well bore, as a function of well depth.

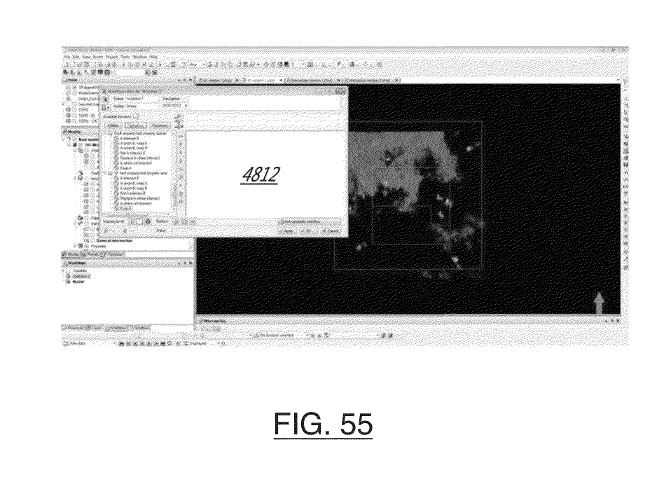

For example, in order to access subsurface geostatistical data and/or bore image data, such processors 102 may be configured to automatically process one or more source files in response to user input received in a graphical user interface (GUI). Files containing source data may be selected using a variety of different known or yet to be conceived techniques. In some cases, for example, files may be processed automatically by a drag and drop operation of the file from a suitable file directory (pointing to either local or remotely stored files) into a processing window (such as can be seen in FIG. 55). Alternatively, operations such as click and/or menu operations may be used to select data files for processing. In addition, files can be selected for processing either individually or in batches.

After a file has been selected for processing, tools 100, 200 may read the selected file(s), in addition to other data or metadata associated with the file(s), in order to make one or more determinations and/or associations as to the contents of the selected file(s). For example, the tools 100, 200 may read the name of the file, any part or all of the content of the file, header or other metadata stored in the file, directory structure, etc. In some cases, depending on the file type, optical character recognition (OCR) processes may be used to read and extract the contents of a file. Alternatively, file types having indexed content can be accessed and read directly using software, applications, scripts, etc. configured to read that file type.

Based on the accessed (meta)data, tools 100, 200 may determine an item, for example, a particular well, to which the data file relates, as well as the content of the data file (e.g., the type of geostatistical data stored, whether the data file contains bore image data, etc.). By identifying the item to which the geostatistical or enterprise data relates, tools 100, 200 may thereby automatically associate the data with relevant map data without further user input. Such associated data may thereby be accessible by a user navigating a GUI.

Tools 100, 200 may also in some cases be configured to modify or otherwise manipulate source data files in order to arrange the contained geostatistical and/or enterprise data into a different or more convenient form, such as a composite of associated data contained in different source files. As further examples, source data files may commonly contain information that is redundant, irrelevant, indiscernible or otherwise missing, not required or not useful. Thus, tools 100, 200 may access source data files and delete or modify information, as well as export information from source data files into newly created files having a more convenient or readable format. As some specific examples, files in spreadsheet format can be converted into CSV files, rows and/or columns of irrelevant or missing data may be deleted, row/column headings may be added or modified, etc.

When the data contained within a source file has been accessed and, optionally, processed, tools 100, 200 may then automatically associate the extracted geostatistical and/or enterprise data with map information to which it relates. Thus, for example, as can be seen in FIGS. 57, 60, and 61 once geostatistical and/or enterprise data for a particular well bore has been extracted and associated, a user will be able to access such information through tools 100, 200 by navigating to that well bore and using any of the available commands programmed into a GUI, as described herein. In such case, the information will be available without the user having to manually associate the data (association is accomplished automatically by processor(s) 102 extracting identifying information for the data from within the files themselves).

In the case of bore image data, tools 100, 200 may also be configured to automatically process source data files so as to extract different pieces of information and organize the bore image data according to well depth. For example, as noted above, FIG. 58 shows core images 5710, 5810 that can be processed and organized by tools 100, 200. FIGS. 57, 60, and 61 described further below show composites of core image data arranged, as a function of well depth, by tools 100, 200 according to different embodiments.

In some cases, tools 100, 200 utilize an automatic identification/extraction algorithm that is programmed to search for one or more characteristic features of core images 5710, 5810 (shown in FIG. 58) in order to locate identifying information (such as the well's uniquely-identifying serial number) for the image data. Thus, for example, such algorithm may be programmed to detect borders, frames, panes, and other image features in order to ascertain an approximate location of certain identifying data within core images 5710, 5810. For example, core images 5710, 5810 may be provided in a standard or pseudo standard format in which specific information of interest (e.g., depth range) is known to be proximately located to different detectable features (e.g., borders, frames) of core images 5710, 5810. Once located, tools 100, 200 may then search for anticipated words or other text, including the words “Top” and “Bottom”, which may be located in close proximity to numerals representing the depth limits of the core image. By locating these characteristic features of the core image 5710, 5810, tools 100, 200 are able to automatically identify and extract (e.g., using an OCR or other suitable process) the limits for the core sample as metadata.

In some cases, processor(s) 102 may be further configured to identify frames or other regions within core images 5710, 5810 that contain the image data itself, as opposed to other frames or regions of core images 5710, 5810 containing other types of data or meta data, whether useful or not, such as depth range, identifying information, etc. So as to generate a more intuitive composite image, or for any other reason, processor(s) 102 may be configured also to extract the core image data, once located, as a separate image so as to eliminate other information from the core images 5710, 5810 that is not required. Thus, for example, as seen in FIGS. 57, 60, and 61, composite images may by generated by extracting image data from individual files and filtering or removing other types of information or data.

Tools 100, 200 are configured to process multiple images taken of the same well core, and to automatically organize the different images according to well depth range (which has been automatically detected and extracted as metadata) as can be seen in FIGS. 57, 60, and 61. Thus, when a user requests more information about a particular well, tools 100, 200 can display a composite image as a function of well depth associated with other geostatistical and/or enterprise data for the well, as described herein. When the user request access to core image data for a particular well, tools 100, 200 may then automatically arrange all the available core image data, as a function of core depth, in conjunction with other geostatistical data for the particular well, as described herein.

In some cases, processor(s) 102 may also be configured, when generating composite images or processing multiple core images 5710, 5810, to identify depth ranges in which core image data is missing or unusable. Thus, such absence of useable data can be noted in a composite image generated for the particular well. FIG. 59 shows a composite core image containing missing core data that has been generated from a plurality of different individual images and arranged as a function of core depth. As can be seen, the depth range of the missing information has been specifically noted.

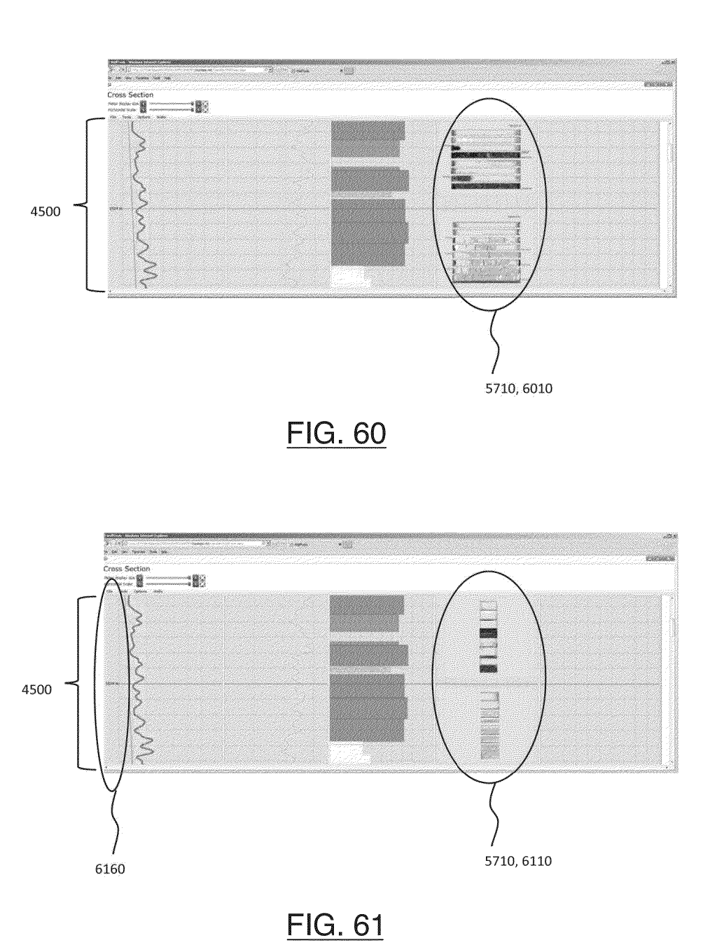

Thus, FIGS. 57, 60 and 61 show example windows 4500 showing geostatistical information associated with a well bore as a function of well depth. FIG. 60 shows the geostatistical information displayed in alignment with stacked horizontal core images 5710, 6010 (similar to the stacked images in FIG. 58) as a function of well depth.

In FIGS. 57 and 61, the geostatistical information is displayed in alignment with a composite image (similar to the composite image in FIG. 59) as a function of well depth. The composite image 6110, can in some examples, be generated by reorienting/rotating, rearranging, aligning, merging or otherwise applying image processing to individual images 5710 such as the individual stacked images in FIG. 58. In some examples, the images may be scaled, aligned or arranged to correspond with the well depth scale 6160 of the geostatistical data.

In FIGS. 57 and 61, the stacked horizontal core images 5810 as seen in FIG. 58, have been rotated and aligned end to end to correspond with the well depth scale 6160 of the geostatistical data.

Among the many powerful features enabled by tools 100, 200 according to the disclosure is the building, storage, and use of extremely flexible geostatistical analysis tools, drawing on the very wide range of data and types of data made available by the networking and accessing of resource(s) 104, 106, 108.

In providing such analysis tools, the invention enables a user to access coded algorithms or formulas (sometimes referred to as analysis “recipes”) available through resource(s) 104, 106, 108, to build new algorithms, and/or to add to or other modify either of such algorithm types for repeated, modified, or expanded use in future, with multiple geological, enterprise, and/or geostatistical data sets.

In providing such analysis tools, the invention enables users to select from available previously-created recipes, which may have been created wholly or partially by the user, by one or more other users associated with a common group or enterprise, or by third parties such as academics, governmental organizations, or other business enterprises. Such users are further enabled to provide, either interactively and/or via coded reference to local and/or other networked resource(s) 104, 106, 108, input(s) required for each recipe or algorithmic step; to check recipes, either accessed from others or wholly or partially built by the user, for valid and complete analytic settings; to run the recipes; and to store all or portion(s) of the recipes for later development and/or use.

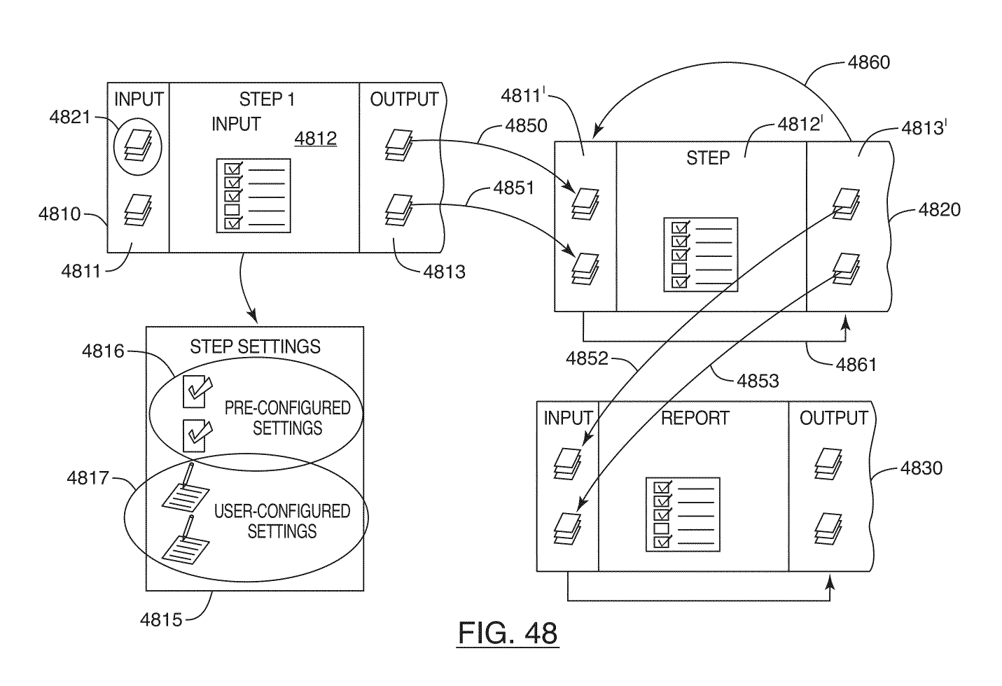

An example of an implementation of such aspect(s) of the invention is described through reference to FIG. 48. Starting from any suitable state of a suitably-configured geological analysis tool 100, 200, such as selection of an interactive GUI control item 4095 of FIG. 40, a user can invoke a geostatistical analysis tool, and thereby cause generation and display by processor(s) 102 of an interactive interface screen 4810. Such user can then select from recipe list 4811 any desired existing analysis recipe from a library of previously created recipes, which library can include any or all of recipes generated by the particular user, any colleagues in a common enterprise, or any third-party recipes. Alternatively, the user can select a ‘new recipe’ item 4821 to start a new analysis tool generation application.

In any such cases, selection of an existing recipe or of a new-tool generation application can result in display of an interactive GUI command feature 4812, comprising for example a menu 4815 comprising command items 4816 adapted to allow the user to select any or all existing recipe steps for use in an analysis of current interest, and items 4817 for creation of new recipe step(s) to be used in the current analysis and/or to be stored for future use with the same and optionally other recipes. Selection of either item(s) 4816, 4817 can enable the user, through the use of further suitably-configured interactive GUI elements, to associate any desired algorithmic steps with suitable data from any or all of resources 104, 106, 108. Any or all such steps can be saved in pre-existing, new, or modified form, as desired, and used alone or in any desired combination(s) for analysis purposes.

Having designated at 4812 any desired recipe steps to be used in a recipe of current interest, by selecting one or more “output” GUI elements 4813 a user can designate one or more desired forms or results of output of the recipe step(s) defined at 4812. For example, a user can define recipe (steps) for generation of output data in any desired form, as for example in one or more formats for printing of reports, for saving in databases for varieties of future use, etc. Output(s) designated at 4813 can further include coded instruction sets corresponding to newly defined, modified, or confirmed algorithmic steps.

As noted at 4890, recipe step(s) defined at 4811-4813, a first, or other single, step in a multi-step analysis, which may of course comprise multiple optional or alternative steps. In such cases analytical recipe processes in accordance with the invention enable the construction, modification, and use of multiple, optionally alternative, streams of algorithmic process, as suggested for example by process flow arrows 4850, 4851, 4852, 4853.

Further step(s) in such multi-step recipe(s) can, as shown at 4820, be defined through multiple applications of the process 4811-4813, with multiple different sets of inputs, outputs, and input sources and streams being defined. Thus, as shown at 4860, 4861, steps 4811′, 4812′, 4813′ can be repeated until all desired input, analysis, and output steps have been defined, implemented, and or saved for future use, as desired.

At each recipe step 4812, 4812′, a user is provided with the functionality to hard-code data, algorithmic, and/or resource input, or to allow the user to enter such data, or override defaults provided by the system 100, 200, or by previously-defined recipe steps. In all such cases, suitable GUI indicators, designed to notify a user of the need to provide appropriate input or input resources, can be provided. Indicators can also be provided for, among other examples, steps that provide global or other broadly-applicable outputs.

First step(s) 4812 can be used to provide or enable user setup of global settings, i.e., settings to be used throughout the entirety of an analysis. Such setting can include, for example, model resolution(s), geographic or geological areas or regions to be modeled, list(s) of wells or other enterprise features to be included, etc.

Recipe-building or modifying processes according to the invention may, as previously noted, provide manual or automatic means to enable a user to check the recipe for appropriate inputs of all types, prior to running analyses. For example, such check processes may include enabling user(s) to confirm that all input(s) and output(s) are properly matched; to provide notifications where manual input will be required in order for an analysis to proceed, including for example GUI pop-up alerts, e-mail or SMS or other message notifications, etc. GUI, messaging, and/or other notifications, which may include output content, can also be provided when final output(s) are available.

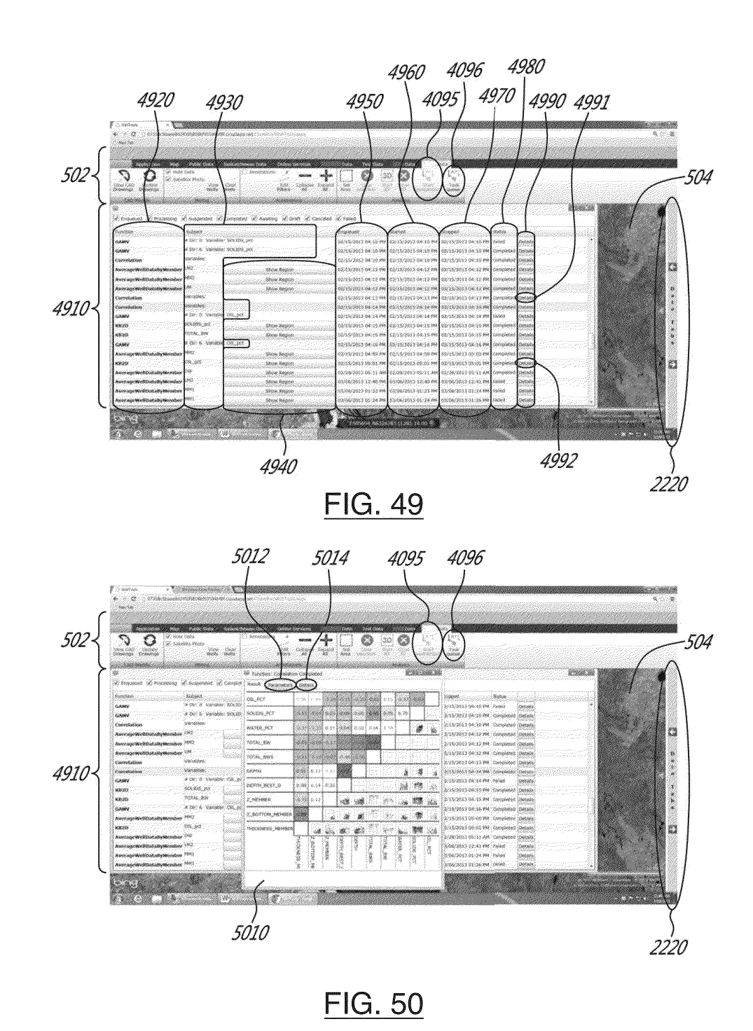

An example of a tool provided by the invention for monitoring the process of one or more analysis recipes, as they are executed, is shown in FIG. 49. In the example shown, an analysis status window 4910 comprises a list 4920 of analyses in various stages of execution, with GUI elements 4990 adapted to enable access to details of the various analysis processes. Such a listing can be accessed by, for example, selecting a GUI element 4096 “task queue.”

In the embodiment shown, process monitoring window 4910 comprises a list 4920 of analyses, by recipe name. “Subject” list 4930 provides a listing of input(s) used by the analyses identified at 4920, and includes interactive GUI elements 4940 which provide means for invoking processes for generating and displaying data representing geological/geographical region(s) associated with the particular analyses, including any relevant enterprise and/or geostatistical data. Selection of such a GUI element 4940 can for example, result in display of a 3-D model of a volume of earth together with any associated geological and/or geostatistical data, as shown in FIGS. 41-44.

Window 4910 of FIG. 49 further provides, in the example shown, columns 4950, 4960, and 4970 indicating the times at which the recipes listed at 4920 were placed into an execution queue, began execution, and stopped, respectively. The status of the process is shown at 4980; at 4990, as previously mentioned, GUI elements “Details” enable a user to access a summary or full listing of the execution history of the corresponding recipe, including for example indications of reasons for any intermediate or ultimate failure(s); sources of input, algorithms, etc., and destinations of any output(s).

FIG. 50 provides an example of a result of selection of a GUI element 4991 “Details” associated with a process “Correlation” in FIG. 49; namely the presentation of an overlay (or “pop-up”) element 5010 providing a summary of output results as shown, with GUI elements 5012, 5014 enabling access to such further information as parameters used in execution of the recipe and details, including any intermediate results, of the execution process.

Thus the invention provides analysis tools, or recipes, that may be prepared in advance, for repeated use (i.e., “canned”), and which may independent of specific input. For example, such recipes can be configured to be independent of geographical, enterprise, and/or geostatistical data input(s).

In various example embodiments, the invention can, alternatively, or additionally, provide a development environment for displaying, modifying and/or executing computer language code corresponding to a geostatistical operation in a recipe or otherwise. FIG. 63 is an example GUI window 6300 showing aspects of an example development environment. The GUI window 6300 can provide an interface for displaying, accessing, editing, compiling, linking, interpreting, executing, or otherwise enabling aspects of developing code corresponding to a geostatistical operation.

The development environment can be configured for developing code in any number of suitable programming languages. In some examples, the development environment can include interfaces and/or features such as line numbering, indentation, colour-coding of known names/terms/syntax, debugging tools, revision control, etc.

In some examples, code provided by or inputted in the development environment can include code for accessing, manipulating, creating and/or storing geostatistical or other data.

The development environment can, in some examples, be configured to generate signals useful for displaying interfaces or aspects of the development environment at a client device/system.

In some example embodiments, the development environment can include elements for defining: a sequence of operations, parameters for each operation, and/or global parameters. In some examples, the development environment can include elements for defining how an output of a designated operation is applied to an input of a subsequent operation.

The development environment can be configured to access, link, import or otherwise refer to stored code files or libraries.

In some examples, the development environment can be configured to be intergrated with, interact with or be activated in response to inputs at a recipe an interface screen 4810, 4820, 4815, 4830, etc.

Thus, in various example embodiments, the invention provides geological analysis tools 100, 200 comprising one or more processors 102 configured to identify geostatistical data associated with one or more subsurface volumes defined at least partly on an input received from a client input device 114, the input representing a selected portion of a geological map from a map data resource 104; access at least one library of geostatistical analysis data sets, or recipes, each accessed library comprising at least one analytic tool data set, or recipe, comprising coded instructions configured to cause the same or another processor to execute one or more geostatistical operations with the geostatistical analysis data set; and perform at least one geostatistical operation on the geostatistical data associated with the subsurface volume. Such tools can further provide any desired sequences of two or more geostatistical analysis operations, or recipe steps, to be performed on such geostatistical data.

Recipe analysis-building, saving, and manipulation tools in accordance with the invention may be applied with particular advantage to a wide variety of analysis types, including for example Krige analysis, locally-varying anisotropy analysis, and projection pursuit multivariate transforms.

Among the various features enabled by the invention, relating to such analysis recipes, is that any or all final and/or intermediate results of analyses produced by execution of such recipes may be stored in any desired memory(ies), including through the use of “cloud” based networked memory(ies) associated with, for example, any resource(s) 104, 106, 108. Such stored intermediate or final results may be accessed and applied in further analyses as desired, with minimal effort and great efficiency.

Such results may further be associated with collaborative or otherwise shared annotations, as described above.

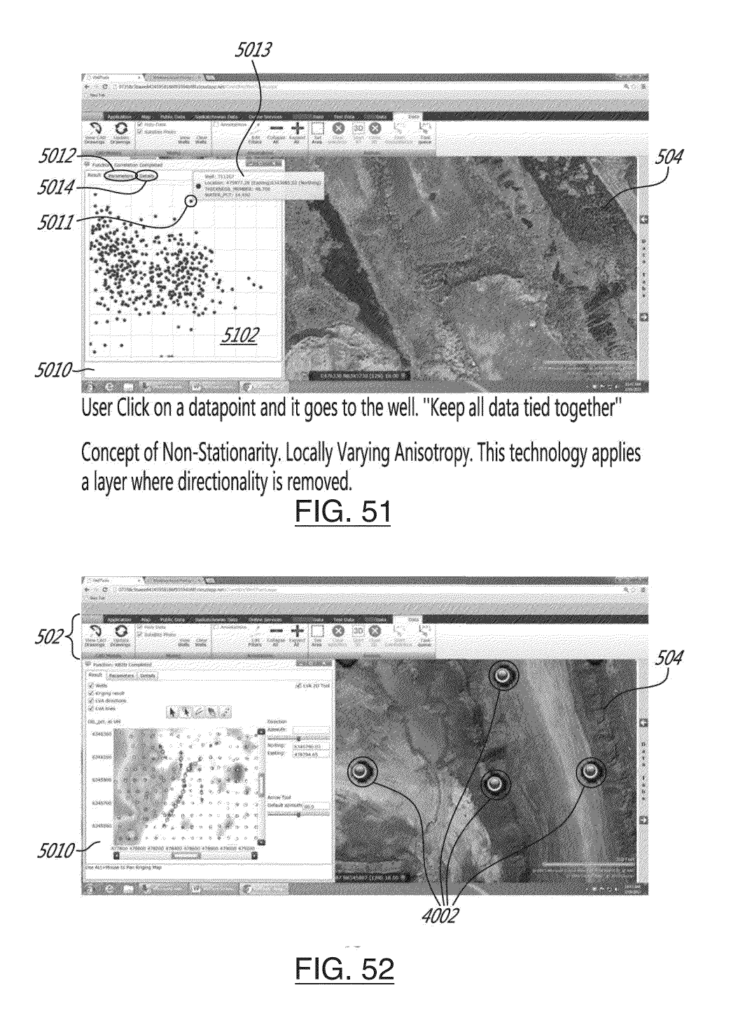

A further example of the powerful analytic opportunities offered by the invention is provided through reference to FIG. 51. In FIG. 51, selection of a GUI “details” element 4991 has resulted in display of a GUI feature 5010 showing results of a two-dimensional analysis of geostatistical data associated with a plurality of petroleum wells. Using a point-and-select input device 114 to place a virtual cursor over one of the data points 5011 shown in the results chart 5102, and allowing it to remain superimposed (to “hover”) over such data point 5011 can result in display of an overlay GUI element 5013 comprising enterprise or other details associated with the corresponding well.

Additionally, in some examples, selecting a data point 5011 using a point-and-select input device 114 or otherwise, can cause the map window 504 to zoom in and/or focus on the location of the well corresponding to the selected data point 5011 and/or to provide full access to the data corresponding to that well. In some examples, associating and linking the data points 5011 to well location and data can allow a user to quickly determine the nature of outliers, unexpected results, etc. to improve the quality, speed, and/or ease of analysis.

Further examples of powerful analytic opportunities offered by the invention are provided through reference to FIGS. 52-55. In FIG. 52, selection of a GUI “details” element 4992 (FIG. 49) has resulted in display of a GUI feature 5010 showing results of a Krige analysis of a volume of earth. In some examples, points on this GUI features 5010 may be selected to access and/or display underlying data and map locations as described in other examples herein.

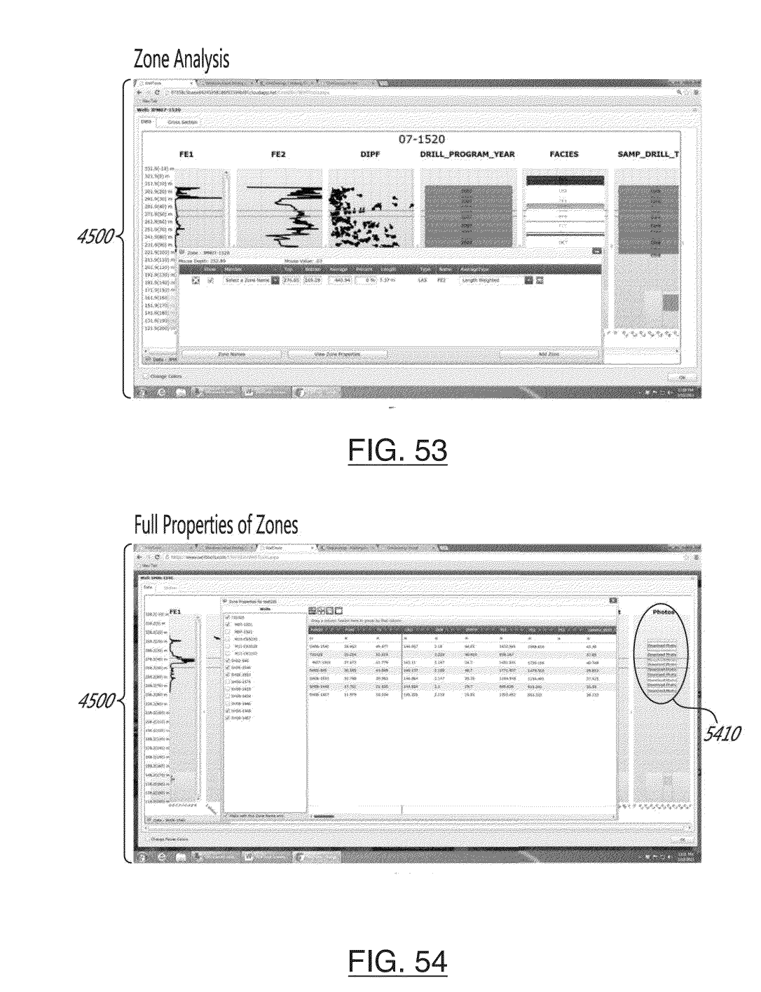

FIGS. 53 and 54 show results 4500 of geostatistical analysis of a defined volume 4110 of earth, determined by interpreting data acquired at a number of points (e.g., wells or wellbores 4002) and extrapolating the results of such determinations to apply to the entire volume 4110. In FIG. 54, links have been provided to corresponding images of the interior surfaces of the wells/bores 4002, as described above.

FIG. 55 provides an alternative embodiment of recipe tool comprising a GUI feature 4812 adapted for controlling input processes and sources for a selected recipe.

A further example of a powerful analysis tool offered by the invention is the ability to accept user input in developing flow field data relating to geological deposits, including for example bitumen, oil, water, and other active or formal flow fields. In some examples, flow fields can be related to deposit anisotropy.

As shown in FIG. 56B, prior art flow visualization systems (“Conventional Models”) frequently fail to interpret geostatistical data associated with mineral or other deposits in such manner as to provide intelligible or otherwise acceptable flow field interpretations. Systems 100, 200 in accordance with the invention enable users to access displays or other data representations, as shown in FIG. 56B “Conventional Models” and to use interactive input devices to generate flow field indicators. For example, at 5600 in FIG. 56B a mineral deposit is shown; a prior art analysis tool has failed to provide any intelligible interpretation of probable flow patterns. Using a system 100, 200 in accordance with the invention, a user has used one or more input device(s) 114 to interact with geostatistical data set(s) 106 in order to associate predicted flow directions with individual points in a volume 4110 lying within the region 5600, and thereafter applied a flow interpolation algorithm to provide a more probable and intelligible picture of the reservoir at 5601. Such improved estimations of flow patterns may be applied, for example, in exploration, drilling, mining, and other enterprises.

For example, in various embodiments the invention provides geological analysis tools, one or more processors 102 configured to display a geological or geostatistical map 504, 5600 representing at least a portion of at least one geological deposit, the geological or geostatistical map associated with data representing direction vectors representing at least one geostatistical property of the reservoir, for example, related to flow, each direction vector based at least partly on direction-vector data; using input generated interactively by a user, determine curve data, which may include data representing one or more zero and/or non-zero vector, associated with the same or other geostatistical properties of the deposit, based on the determined curve data and the direction-vector data, generate data representing at least one modified/hybrid direction-vector associated with the at least one property; and write to volatile or persistent memory data useful for displaying the at least one direction-vector.

Flow-interpretation tools of the type described may be of particular value when generated in multiple two-dimensional layers, in order to represent properties of a three-dimensional deposit.

As will be understood by those skilled in the relevant arts, associations between map, enterprise, and geostatistical data for scaling, interpolating, extrapolating, and other mapping and analysis purposes as described herein may be made in any suitable manner(s). Such manner(s) can, for example, include any or all suitable forms of indexing, relating, creating metadata, etc.

Similarly, graphic representations of geological, enterprise, and other features for display and other purposes may be provided in any suitable form(s), including for example indicia such as symbols, images, renderings or other visual representations of subsurface geostatistical information associated with at least one location on the surface of the earth. Signals suitable for generating such images can be provided in forms representing pixel data, frame data, vector data, primitives and the like.

In any embodiments described herein, the tool can be configured to allow for multi-monitor or multi-window support. In some examples, different GUIs or GUI features can be displayed in different windows. These windows can be displayed across the same or different web browser windows, applications, display devices, locations and/or devices. For example, different windows can each display different information such as maps, well production data, core images, etc.

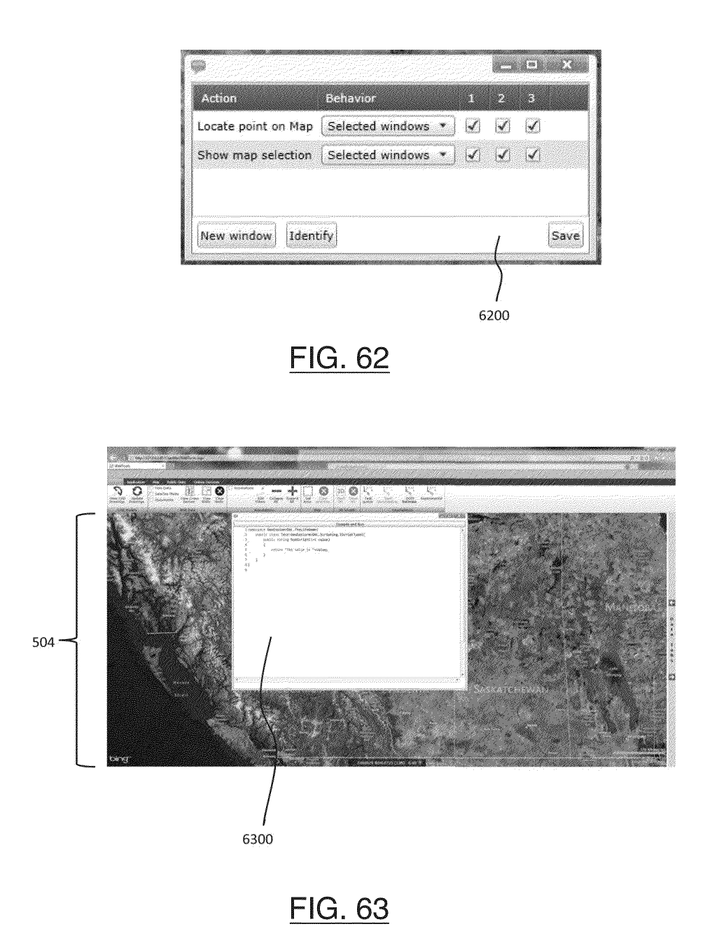

In some examples, a user can configure which windows react and zoom to appropriate map locations or data when a user activates or selects one or more data points or objects, and which windows remain unaffected by such actions. FIG. 62, shows an example GUI 6200 for the control of the behavior of multiple windows when a point is located on a map, or when a map selection is shown.

In some examples, the tool can be configured to create a new application window, to identify windows for control purposes (for example, by displaying a window number or identifier), and/or to save settings. Windows can, in some example, be closed via normal operating system methods.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

1. A geological analysis tool, comprising one or more processors configured to:
associate, with surface map data accessed from at least one networked surface map data resource:
enterprise data accessed from one or more enterprise data resources, and
subsurface geostatistical data accessed from the same or other data resources; and
generate, using at least portions of the associated map data, enterprise data, and geostatistical data, signals useful for displaying a geological map comprising indicia representing subsurface geostatistical information associated with at least one location on the surface of the earth; and
write the generated signals to at least one memory accessible by at least one display device.

2. The tool of claim 1, wherein the networked map data resource comprises at least one dynamically-updated surface data.

3. The tool of claim 1, wherein the one or more processors is configured to access at least one analytic tool, the analytic tool configured to enable the same or at least one other processor to execute at least one analysis of geostatistical data associated with at least a portion of the geological map.

4. The tool of claim 1 wherein the enterprise data relates at least to a drilled well.

5. The tool of claim 1, wherein the enterprise data relates at least to a mine.

6. The tool of claim 1, wherein the enterprise data relates at least to recovery of geothermal energy.

7. The tool of claim 1, wherein the enterprise data relates to at least one subsurface resource deposit.

8. The tool of claim 1, wherein the one or more processors is configured to access at least one enterprise analytic tool, the enterprise analytic tool configured to enable the same or at least one other processor to execute at least one analysis of the same or other enterprise data associated with at least a portion of the geological map.

9. The tool of claim 1, wherein the signals useful for displaying a geological map are generated at least partly using a graphics visualization tool that enables selective rendering and manipulation of data to be written to memory for display.

10. The tool of claim 9, wherein the graphics visualization tool enables selective rendering of data based on a zoom level.

11. The tool of claim 9, wherein the graphics visualization tool enables selective rendering of data based on a projection orientation.

12. The tool of claim 1, wherein when an update to the surface map data, the enterprise data, or the subsurface geostatistical data is detected, the one or more processors are configured to associate the updated data.

13. The tool of claim 1, wherein the one or more processors are configured to provide authentication information to access one or more of the data resources.

14. A geological analysis tool, comprising one or more processors configured to:
in response to signals representing a command to display well bore image data, access data representing a plurality of images of at least a portion of an interior surface of a well bore;
using the accessed image data, generate signals useful for displaying on a display device a composite image representing at least a portion of the plurality of images, the generated signals configured to scale the displayed composite image to fit a predetermined portion of a display screen; and
in response to signals representing a user designation of a portion of the displayed composite image, generate signals useful for displaying on a display device an enlarged view of the designated portion.

15. The tool of claim 14, wherein:
the one or more processors are configured to access subsurface geostatistical data associated with the well bore, and
the generated signals configured to scale the displayed composite image to fit a predetermined portion of a display screen are configured to display the composite image in alignment with geostatistical information associated with the well bore, as a function of well depth.

16. A geological analysis tool, comprising one or more processors configured to:
in response to signals representing a command to display well bore image data,
access data representing a plurality of images of at least a portion of an interior surface of a well bore;
access subsurface geostatistical data associated with the well bore, and
using the accessed image data and geostatistical data, generate signals useful for displaying on a display device a composite image representing at least a portion of the plurality of images,
the generated signals configured to
scale the displayed composite image to fit a predetermined portion of a display screen; and
display the scaled composite image in alignment with associated geostatistical information, as a function of well depth.

17. The tool of claim 16, wherein the one or more processors are configured to:
in response to signals representing a user designation of a portion of the displayed composite image, generate signals useful for displaying on a display device an enlarged view of the designated portion.

18. The tool of claim 16 wherein the subsurface geostatistical data includes oil or gas concentration data.

19. The tool of claim 16 wherein the subsurface geostatistical data includes mineral content data.

20. The tool of claim 16 wherein the subsurface geostatistical data includes water content data.

21. The tool of claim 16 wherein the subsurface geostatistical data includes geothermal data.

22. The tool of claim 16, wherein the one or more processors are configured to access at least one enterprise analytic tool, the enterprise analytic tool configured to enable the same or at least one other processor to execute at least one analysis of at least a portion of the subsurface geostatistical data.

23. The tool of claim 16, wherein the generated signals configured to scale the displayed composite image to fit a predetermined portion of a display screen are configured to display the composite image in alignment with multiple sets of separately displayed geostatistical information.

24. The tool of claim 16, wherein generating the signals useful for displaying on a display device a composite image representing at least a portion of the plurality of images comprises:
applying image processing to individual images before displaying the processed individual images as a composite image.

25. The tool of claim 24, wherein applying image processing comprises:
reorienting, rearranging, or aligning the individual images.

26. The tool of claim 16, wherein the one or more processors are further configured to:
determine a respective well depth for each of the plurality of images using an automatic character recognition process; and
based on the determined well depth of each respective image, arrange the plurality of images within the composite image as a function of well depth.
